(19) United States
(12) Patent Application Publication
(10) Pub. No.: US 2011/0132232 A1
(43) Pub. Date: Jun. 9, 2011

(54) Polyol-Based Admixtures for Hydraulic Cement

(76) Inventors: Lionel Catalan, Thunder Bay (CA); Stephen D. Kinrade, Thunder Bay (CA)

(21) Appl. No.: 12/906,887

(22) Filed: Oct. 18, 2010

Related U.S. Application Data
(60) Provisional application No. 61/252,451, filed on Oct. 16, 2009.

(51) Int. Cl. C04B 28/02; C04B 28/06; C04B 28/04; C04B 28/08; C04B 28/22

(52) U.S. Cl. 106/695; 106/696; 106/802; 106/724; 106/790; 106/708

(57) ABSTRACT

Described herein is a composition including a substantially potash-free hydraulic cementitious material and at least one polyol compound having an acyclic polyhydroxy backbone chain comprising four or five adjacent carbon atoms, wherein a hydroxyl group is attached to each carbon of the backbone chain, and wherein the composition includes an effective amount of at least one calcium silicate or calcium aluminate material in a crystalline phase. Also described herein is a composition including a substantially calcium hydroxide-free hydraulic cementitious material and at least one polyol compound having an acyclic polyhydroxy backbone chain comprising four or five adjacent carbon atoms, wherein a hydroxyl group is attached to each carbon of the backbone chain, and wherein the composition includes at least one alkali-activated binder. Also described herein are methods and admixtures for increasing the strength of a hydraulic cementitious material.

### RELATED APPLICATIONS

This application claims the benefit of the filing date of U.S. Patent Application No. 61/252,451, filed on 16 Oct. 2009, the contents of which are incorporated herein by reference in their entirety.

### FIELD OF THE INVENTION

This invention relates to admixtures for enhancing strength and/or controlling setting time of hydraulic cement. Further, this invention relates to admixtures for enhancing strength and/or controlling setting time of hydraulic cement in mortars and concretes.

### BACKGROUND OF THE INVENTION

Admixtures may be used with hydraulic cement to improve one or more properties of the cement relating to workability, rheology, water requirement, strength, air content, and setting time. There has been particular interest in the use of admixtures to delay the onset of setting without adversely affecting the material's long-term mechanical properties. Such admixtures, referred to as “retarders”, may be used to compensate for high temperatures, which accelerate setting, or for delays between cement mixing and placement. Common organic retarders include certain sugars, lignosulfonates, and hydroxycarboxylic acids. For example, sucrose is an effective retarder; addition of 0.075 wt % to ordinary portland cement (OPC) increases the set time from approximately 2.5 hours to 31 hours [1]. Water reducing plasticizers (e.g., lignosulfonates) are another common type of admixture used either to increase the workability while keeping the water-to-cement ratio (W/C) constant or to reduce the W/C for a given workability. Superplasticizers are high range water reducers manufactured from sulfonated naphthalene condensate, sulfonated melamine formaldehyde, polycarboxylic ethers, or polycarboxylate. Superplasticizers allow the concrete mixture to remain workable at lower W/C than classical water reducers. Reduced porosity and increased strength are achievable with superplasticizers because of reduced water content.

Although there has been substantial interest in cement additives to improve properties such as workability, water requirement, and setting time, much less work has been devoted to additives for improving the strength of cement at a given water-to-cement ratio.

### SUMMARY OF THE INVENTION

A first aspect provides an additive for a hydraulic cementitious material that increases the strength of the cement at a given water-to-cement ratio and controls setting time of the cement. The additive may be a polyol compound, or a derivative thereof. More specifically, it may be a polyol described by the chemical formula

C(OH)(R₁,R₁′)C(OH)(R₂)C(OH)(R₃)C(OH)(R₄,R₄′) (1)

or

C(OH)(R₁,R₁′)C(OH)(R₂)C(OH)(R₃)C(OH)(R₄)C(OH)(R₅,R₅′) (2)

where Rₓ and Rₓ′ represent radicals that do not contain an alcohol group in the α-position.

An underivatized polyol may be added to cement in a range of, for example, about 0.01% to about 5%, about 0.05% to about 3%, or about 0.1% to about 1% of the dry weight of the cementitious material. Where a derivatized polyol is used, the concentration may be increased in proportion to the molecular weight of the derivatized polyol.

One embodiment provides a composition including a hydraulic cementitious material and a polyol compound having an acyclic polyhydroxy backbone chain comprising four or five adjacent carbon atoms, wherein a hydroxyl group is attached to each carbon of the backbone chain.

A second aspect provides a method of increasing strength of a hydraulic cementitious material, comprising adding to the cement a polyol compound having an acyclic polyhydroxy backbone chain comprising four or five adjacent carbon atoms, wherein a hydroxyl group is attached to each carbon of the backbone chain. The method may comprise mixing the polyol compound with water to obtain a solution, and mixing the solution with the cement.

A third aspect provides an admixture for a hydraulic cementitious material, comprising at least one polyol compound having an acyclic polyhydroxy backbone chain comprising four or five adjacent carbon atoms, wherein a hydroxyl group is attached to each carbon of the backbone chain. The admixture may comprise an aqueous solution including a polyol compound.

In the above aspects, the polyol compound may be described by the chemical formula

C(OH)(R₁,R₁′)C(OH)(R₂)C(OH)(R₃)C(OH)(R₄,R₄′) (1)

or

C(OH)(R₁,R₁′)C(OH)(R₂)C(OH)(R₃)C(OH)(R₄)C(OH)(R₅,R₅′) (2)

where Rₓ and Rₓ′ represent radicals that do not contain an alcohol group in the α-position.

In the above aspects, the hydraulic cementitious material includes one or more of dicalcium silicate (C₂S), tricalcium silicate (C₃S), tricalcium aluminate (C₃A), and tetracalcium aluminoferrrite (C₄AF), or portland cement, optionally together with an alkali-activated binder, or combinations thereof, wherein the alkali-activated binder is a material formed by alkali-, silicate-, carbonate- or sulfate-activation of a reactive silicate or aluminosilicate phase such as metallurgical slag, fly ash, cullet, or mineral such as kaolinite or metakaolinite. In the above aspects, embodiments may include a polyol compound selected from erythritol, threitol, adonitol, xylitol, or arabitol, or a combination thereof.

A fourth aspect provides a composition including a substantially calcium hydroxide-free hydraulic cementitious material and at least one polyol compound having an acyclic polyhydroxy backbone chain. In some embodiments, the polyol compound may comprise three to six adjacent carbon atoms, wherein a hydroxyl group is attached to each carbon of the backbone chain. In other embodiments, the polyol compound may comprise four or five adjacent carbon atoms, wherein a hydroxyl group is attached to each carbon of the backbone chain. In some embodiments the hydraulic cementitious material includes at least one alkali-activated binder. In a further embodiment the hydraulic cementitious material includes sodium silicate.

A fifth aspect provides a method of increasing strength of a substantially calcium hydroxide-free hydraulic cementitious material, comprising adding to the hydraulic cementitious material at least one polyol compound having an acyclic polyhydroxy backbone chain. In some embodiments, the polyol compound may comprise three to six adjacent carbon atoms, wherein a hydroxyl group is attached to each carbon of the backbone chain. In other embodiments, the polyol compound may comprise four or five adjacent carbon atoms, wherein a hydroxyl group is attached to each carbon of the backbone chain. In some embodiments the hydraulic cementitious material includes at least one alkali-activated binder. In a further embodiment the hydraulic cementitious material includes sodium silicate. The method may comprise mixing the at least one polyol compound with water to obtain a solution, and mixing the solution with the hydraulic cementitious material.

A sixth aspect provides an admixture for a substantially calcium hydroxide-free hydraulic cementitious material, comprising at least one polyol compound having an acyclic polyhydroxy backbone chain. In some embodiments, the polyol compound may comprise three to six adjacent carbon atoms, wherein a hydroxyl group is attached to each carbon of the backbone chain. In other embodiments, the polyol compound may comprise four or five adjacent carbon atoms, wherein a hydroxyl group is attached to each carbon of the backbone chain. In some embodiments, the hydraulic cementitious material includes at least one alkali-activated binder. In a further embodiment the hydraulic cementitious material includes sodium silicate. The admixture may comprise a solution including the at least one polyol compound.

In the fourth to sixth aspects, the alkali-activated binder may be slag, natural pozzolan, silica fume, fly ash, cullet, kaolinite, metakaolinite, or a combination thereof. In embodiments where the at least one polyol compound has 4 to 5 adjacent carbons atoms, the at least one polyol compound may be described by the chemical formula

C(OH)(R₁,R₁′)C(OH)(R₂)C(OH)(R₃)C(OH)(R₄,R₄′) (1)

or

C(OH)(R₁,R₁′)C(OH)(R₂)C(OH)(R₃)C(OH)(R₄)C(OH)(R₅,R₅′) (2)

where Rₓ and Rₓ′ represent moieties (e.g., radicals) that do not contain an alcohol group in the α-position. In some embodiments the at least one polyol compound may be erythritol, threitol, adonitol, xylitol, arabitol, mannitol, or sorbitol, or a combination thereof. In some embodiments, at least one polyol compound may be substantially pure.

A seventh aspect provides a composition including a substantially potash-free hydraulic cementitious material and at least one polyol compound having an acyclic polyhydroxy backbone chain comprising four or five adjacent carbon atoms, wherein a hydroxyl group is attached to each carbon of the backbone chain, and wherein the hydraulic cementitious material includes at least one calcium silicate material in a crystalline phase or at least one calcium aluminate material in a crystalline phase, or a combination thereof. The hydraulic cementitious material may optionally include an alkali-activated binder.

An eighth aspect provides a method of increasing strength of a substantially potash-free hydraulic cementitious material, comprising adding to the hydraulic cementitious material at least one polyol compound having an acyclic polyhydroxy backbone chain comprising four or five adjacent carbon atoms, wherein a hydroxyl group is attached to each carbon of the backbone chain, and wherein the hydraulic cementitious material includes at least one calcium silicate material in a crystalline phase or at least one calcium aluminate material in a crystalline phase, or a combination thereof. The hydraulic cementitious material may optionally include an alkali-activated binder. The method may comprise mixing the at least one polyol compound with water to obtain a solution, and mixing the solution with the hydraulic cementitious material.

A ninth aspect provides an admixture for a substantially potash-free hydraulic cementitious material, comprising at least one polyol compound having an acyclic polyhydroxy backbone chain comprising four or five adjacent carbon atoms, wherein a hydroxyl group is attached to each carbon of the backbone chain, and wherein the hydraulic cementitious material includes at least one calcium silicate material in a crystalline phase or at least one calcium aluminate material in a crystalline phase, or a combination thereof. The hydraulic cementitious material may optionally include an alkali-activated binder. The admixture may comprise a solution including the at least one polyol compound.

In the seventh to ninth aspects, the alkali-activated binder may be slag, natural pozzolan, silica fume, fly ash, cullet, kaolinite, metakaolinite, or a combination thereof. The at least one polyol compound may be described by the chemical formula

C(OH)(R₁,R₁′)C(OH)(R₂)C(OH)(R₃)C(OH)(R₄,R₄′) (1)

or

C(OH)(R₁,R₁′)C(OH)(R₂)C(OH)(R₃)C(OH)(R₄)C(OH)(R₅,R₅′) (2)

where Rₓ and Rₓ′ represent moieties (e.g., radicals) that do not contain an alcohol group in the α-position. In some embodiments the at least one polyol compound may be erythritol, threitol, adonitol, xylitol, arabitol, or a combination thereof. In some embodiments, at least one polyol compound may be substantially pure.

### BRIEF DESCRIPTION OF THE DRAWINGS

For a better understanding of the invention, and to show more clearly how it may be carried in effect, embodiments will be described below, by way of example, with reference to the accompanying drawings, wherein:

FIG. 1 is a plot showing strength development in cement pastes containing xylitol or threitol. Polyol concentrations are given in percent of dry cement weight. Error bars correspond to ±one standard deviation.

FIG. 2 is a plot showing strength development in concrete containing xylitol. Xylitol concentrations are given in percent of dry cement weight. Error bars correspond to ±one standard deviation.

FIG. 3 is a plot showing effect of polyol compounds on the degree of hydration and the final setting time of tricalcium silicate (C₃S) at 21±1° C. Polyol concentrations are given in mole percent of C₃S.

FIG. 4 is a plot showing dependence of the final setting time of C₃S paste on polyol concentration at 21±1° C. Polyol concentrations are given in mole percent of C₃S. Data are fitted to Equation 2 (solid lines) as described in Table 15.

FIG. 5 is a plot showing dependence of the initial setting time of OPC paste on saccharide concentration at 23±1° C. Saccharide concentrations are given in weight percent of OPC. Data are fitted to equation 2 (solid lines) as described in Table 15.

FIG. 6 is a plot showing effect of sucrose or sorbitol addition on the degree of hydration of OPC paste at 21±1° C. Sucrose and sorbitol concentrations are given in weight percent of OPC. The expanded graph highlights the first 8 days of curing. Error bars correspond to standard deviations over three measurements. Data are fitted to a 3-parameter single-exponential-rise-to-maximum function.

FIG. 7 is a plot showing effect of sucrose or sorbitol addition on the unconfined compressive strength of OPC at 21±1° C. Sucrose and sorbitol concentrations are given in weight percent of OPC. Error bars correspond to standard deviations over three measurements (eight in the case of day-56).

FIG. 8 is a plot showing compressive strength of concrete cylinders containing no fly ash and having a water-to-cement ratio approximately equal to 0.50. Xylitol concentrations are given in percent of dry cement weight.

FIG. 9 is a plot showing compressive strength of concrete cylinders containing fly ash and having a water-to-cementitious materials ratio approximately equal to 0.50. Xylitol concentrations are given in percent of dry cementitious material (cement+fly ash) weight.

FIG. 10 is a plot showing compressive strength of concrete cylinders containing no fly ash and having a water-to-cement ratio approximately equal to 0.35. Xylitol concentrations are given in percent of dry cement weight.

FIG. 11 is a plot showing compressive strength of concrete cylinders containing fly ash and having a water-to-cementitious materials ratio approximately equal to 0.35. Xylitol concentrations are given in percent of dry cementitious material (cement+fly ash) weight.

FIG. 12 is a plot showing compressive strength of fly ash-based geopolymer mortar as a function of curing time for xylitol concentrations equivalent to 0 wt %, 0.3 wt %, and 0.7 wt % of the fly ash. Error bars correspond to ±one standard deviation over three measurements.

### DETAILED DESCRIPTION OF EMBODIMENTS

Embodiments of the invention provide additives, i.e., polyols, for a hydraulic cementitious material that increase the strength of the cement, mortar and concrete, and control setting time thereof. The embodiments are based, at least in part, on the surprising discovery that certain polyols confer substantial increases in strength to hydraulic cements at a given water-to-cement ratio (W/C). Depending on the polyol and its concentration, the increase in strength of the cement may be realized in addition to a delay in setting of the cement, little or no substantial delay in setting, or accelerated setting.

As used herein, the term “polyol” means an acyclic polyhydroxyl hydrocarbon.

In one embodiment, the polyols are those having a backbone chain of 4 or 5 adjacent carbon atoms, wherein a hydroxyl group is attached to each carbon of the backbone chain. Such polyol compounds, and derivatives thereof, may be described by the chemical formula

C(OH)(R₁,R₁′)C(OH)(R₂)C(OH)(R₃)C(OH)(R₄,R₄′) (1)

or

C(OH)(R₁,R₁′)C(OH)(R₂)C(OH)(R₃)C(OH)(R₄)C(OH)(R₅,R₅′) (2)

where Rₓ and Rₓ′ represent moieties (e.g., radicals) that do not contain an alcohol group in the α-position.

Examples of such polyol compounds include sugar alcohols. As used herein, the term “sugar alcohol” is equivalent to “polyhydric alcohol” and “polyalcohol”, and refers to a hydrogenated form of carbohydrate, whose carbonyl group (aldehyde or ketone, reducing sugar) has been reduced to a primary or secondary hydroxyl group (i.e., alcohol). Exemplary sugar alcohols include, but are not limited to erythritol, threitol, adonitol, xylitol, and arabitol. Thus, as described herein, strength of a cementitious material may be increased by adding thereto a polyol selected from erythritol, threitol, adonitol, xylitol, and arabitol, or a combination thereof.

In other embodiments, one or more polyol having a backbone chain of 4 or 5 adjacent carbon atoms may be combined with one or more other polyol, with the proviso that the one or more polyol having a backbone chain of 4 or 5 adjacent carbon atoms is/are the dominant polyol of the polyol mixture. Such other polyol may have a backbone chain of adjacent carbon atoms that is other than 4 or 5 carbon atoms. For example, in one embodiment such other polyol may be sorbitol, in which case the amount of sorbitol is less than 20% of the total amount of all polyols in the mixture. As a further example, the polyol mixture may include xylitol and sorbitol, wherein the amount of sorbitol is less than 20% of the total amount of xylitol and sorbitol. Other mixtures of polyols for use as described herein may be substantially sorbitol-free, or contain no added sorbitol. However, it is to be understood that a trace amount of sorbitol may be present.

Although not essential, substantially pure polyols may be used. The term “substantially pure” refers to the content of polyol relative to other compounds in a given sample. Polyols with a purity of, for example, greater than 60%, may be used in embodiments of the invention. In other embodiments, the purity may be at least 80%, at least 90%, at least 95%, or at least 99%. For example, a substantially pure polyol may be a food grade polyol. In one embodiment, substantially pure xylitol is used.

An underivatized polyol may be added to cement in a range of, for example, about 0.01% to about 5%, about 0.05% to about 3%, or about 0.1% to about 1% of the dry weight of the cementitious material. Where a derivatized polyol is used, the concentration may be increased in proportion to the molecular weight of the derivatized polyol.

The terms “cement”, “hydraulic cement”, “hydraulic cementitious material”, and “cementitious material” are used interchangeably herein and refer to inorganic material or a mixture of inorganic materials that sets, develops strength and binds together other materials owing to its chemical interaction with water and the resultant formation of hydrates. Such hydraulic cements may be used alone as pastes, or they may be used in mortars, concretes, and the like.

In some embodiments, the hydraulic cementitious material may be substantially calcium hydroxide-free. That is, such an embodiment does not include portland cement in the hydraulic cementitious material. The hydraulic cementitious material contains no added calcium hydroxide, although it is to be understood that a small amount of calcium hydroxide may be present, wherein the amount of calcium hydroxide is less than 5% of the dry weight of the hydraulic cementitious material. The hydraulic cementitious material may include at least one alkali-activated binder. The hydraulic cementitious material may include potash.

In calcium hydroxide-free embodiments, the polyol compound may comprise three to six adjacent carbon atoms, wherein a hydroxyl group is attached to each carbon of the backbone chain. In some embodiments, the polyol compound may comprise four or five adjacent carbon atoms, wherein a hydroxyl group is attached to each carbon of the backbone chain. For example, the at least one polyol compound may be erythritol, threitol, adonitol, xylitol, arabitol, mannitol, or sorbitol, or a combination thereof. In one embodiment the hydraulic cementitious material includes sodium silicate. In other embodiments, the hydraulic cementitious material may be substantially potash-free. That is, the hydraulic cementitious material may contain no added potash, although it is to be understood that a trace amount of potash may be present. In other embodiments, the hydraulic cementitious material may contain potash, wherein the amount of potash is less than 5% of the dry weight of the hydraulic cementitious material. In such embodiments, the hydraulic cementitious material includes as a constituent one or more crystalline calcium silicate materials, such as, for example, dicalcium silicate (C₂S) and tricalcium silicate (C₃S). The hydraulic cementitious material may include as a constituent one or more crystalline calcium aluminate materials, such as, for example, tricalcium aluminate (C₃A) and tetracalcium aluminoferrrite (C₄AF). The hydraulic cementitious material may include an alkali-activated binder as a constituent. In some embodiments, combinations of two or more calcium silicate, calcium aluminate, or alkali-activated binder materials may be present. The hydraulic cementitious material may be 100% portland cement, or it may be less than 100% portland cement, with alkali-activated binder as the remaining material. For example, the hydraulic cementitious material may comprise 75% portland cement and 25% alkali-activated binder, or 50% portland cement and 50% alkali-activated binder, or 25% portland cement and 75% alkali-activated binder, or 1% portland cement and 99% alkali-activated binder.

As used herein, the term “potash” refers to a material substantially comprising potassium carbonate.

The calcium silicate, calcium aluminate, and alkali-activated binder materials may be present in effective amounts. The term “effective amount” as used herein refers to an amount of the material required to achieve a desired strength upon curing of the cement, mortar, or concrete. For example, an effective amount may be an amount of C₂S, C₃S, C₃A, and C₄AF as specified in Tables 1 and 2(a), 2(b) to 7(a), 7(b). As a further example, an effective amount may be a minimum amount as specified in an accepted standard, such as, for example, an ASTM standard.

A typical example of a hydraulic cement is ordinary portland cement (OPC), wherein C₃S is the dominant constituent and exerts the greatest influence on the strength and other characteristics of the hydrated cement (see, e.g., [38]). In general, OPC may include about 37% to 72% of C₃S, and about 6% to 36% C₂S [38]. As discussed in detail in [38], different types of portland cement are manufactured to meet various physical and chemical requirements, and to meet the specifications of ASTM C150, AASHTO M 86, and ASTM C1157 standards. For example, Tables 2(a), 2(b) to 7(a), 7(b) list minimum and maximum amounts (wt %) of C₂S, C₃S, C₃A, and C₄AF in Types Ito V and White Cement, as designated under ASTM C150 and AASHTO M 86. The amounts of these constituents in various types of portland cement give each type certain properties, such that a given type might be desirable for a particular application. Characteristics of Types I to V and White Cement are summarized below, based on [38] (refer to [38] for more information).

### Type I. Normal

A general purpose portland cement suitable for all uses where the special properties of other types of portland cement are not required. Tables 2(a) and 2(b) list minimum and maximum amounts of C₂S, C₃S, C₃A, and C₄AF in flatwork and frost resistant concrete prepared from different amounts of Type I portland cement.

### Type II. Moderate Sulfate Resistance

This portland cement is used where protection against moderate sulfate attack is important. It is used in structures exposed to soil, to ground water where sulfate concentrations are higher than normal but not severe, or to seawater. Moderate sulfate resistance arises because it contains no more than 8% tricalcium aluminate (C₃A). Tables 3(a) and 3(b) list minimum and maximum amounts of C₂S, C₃S, C₃A, and C₄AF in flatwork and frost resistant concrete prepared from different amounts of Type II portland cement.

### Type III. High Early Strength

This portland cement develops substantial strength early, e.g., one week or less, and consequently it may be used when forms need to be removed as soon as possible or when the structure must be put into service quickly. In cold weather it permits a reduction in the duration of the curing period. Tables 4(a) and 4(b) list minimum and maximum amounts of C₂S, C₃S, C₃A, and C₄AF in flatwork and frost resistant concrete prepared from different amounts of Type III portland cement.

### Type IV. Low Heat of Hydration

This portland cement is used where the rate and amount of heat generated from hydration must be minimized, such as in massive structures such as large gravity dams. It develops strength at a slower rate than other cement types. Tables 5(a) and 5(b) list minimum and maximum amounts of C₂S, C₃S, C₃A, and C₄AF in flatwork and frost resistant concrete prepared from different amounts of Type IV portland cement.

### Type V. High Sulfate Resistance

This type of portland cement is used in concrete exposed to severe sulfate action, such as where soil or ground water has a high sulfate content. It develops strength more slowly than Type I cement. The high sulfate resistance results from a low C₃A content of 5 wt % or less. Tables 6(a) and 6(b) list minimum and maximum amounts of C₂S, C₃S, C₃A, and C₄AF in flatwork and frost resistant concrete prepared from different amounts of Type V portland cement.

### White Cement

This portland cement differs from grey cement primarily in colour. The manufacturing process is controlled using selected materials so that the finished product is white. It is used for architectural applications in structural elements where a white finish is desired. Tables 7(a) and 7(b) list minimum and maximum amounts of C₂S, C₃S, C₃A, and C₄AF in flatwork and frost resistant concrete prepared from different amounts of white portland cement.

It should be noted that the first row in Tables 2(a), 2(b) to 7(a), 7(b) shows the amounts of C₂S, C₃S, C₃A, and C₄AF in the specified cement type when the minimum amount of cement is used. The minimum amount of cement is 280 kg for 1 m³ of flatwork concrete and 335 kg for 1 m³ of frost-resistant concrete. Subsequent rows in Tables 2(a), 2(b) to 7(a), 7(b) show the amounts of C₂S, C₃S, C₃A, and C₄AF in the specified cement type when the minimum amount of cement has been diluted by addition of one or more other cementitious materials, such as one or more alkali-activated binders.

As used herein, the terms “cement”, “hydraulic cement”, hydraulic cementitious material”, and “cementitious material” also refer to compositions including one or more calcium silicate, calcium aluminate, and alkali-activated binder materials referred to above, together with one or more other materials that may or may not include one or more calcium silicate, calcium aluminate, or alkali-activated binder material. These materials may be used to prepare hydraulic cement for particular usages, such as lime slag cement, masonry cement, natural cement, supersulfated cement, natural or artificial hydraulic limes; and mixes such as mortars, grouts, renders, and concretes, based on cement and/or lime, on water and/or on aggregates of all particle sizes (sands, gravels, stones, etc). Alkali-activated binders (also known as “geopolymers” or “inorganic polymers”) are materials formed by alkali-, silicate-, carbonate- or sulfate-activation of a reactive silicate or aluminosilicate phase, including slags (e.g., ground granulated blast furnace slag (ggbfs)), natural pozzolan, silica fume, fly ash, cullet, minerals (e.g., kaolinite, metakaolinite), and combinations thereof. Materials such as fly ash and slag typically do not contain crystalline phases of calcium silicates (see, e.g., [39, 40]) in effective amounts.

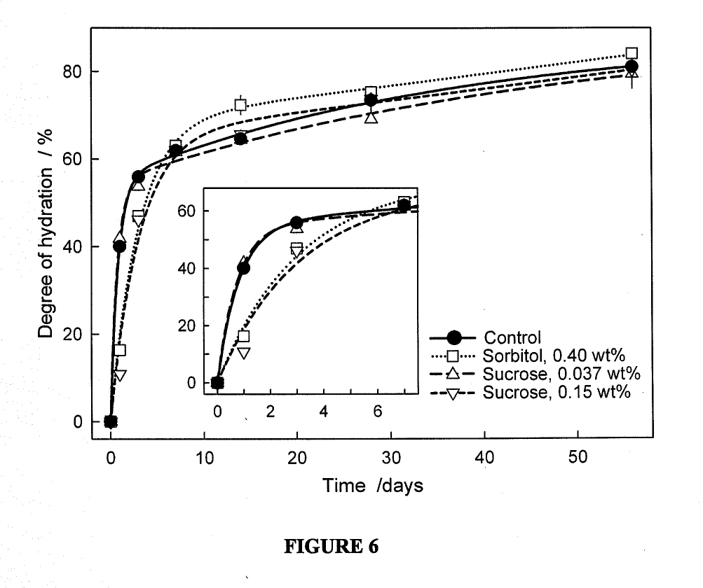

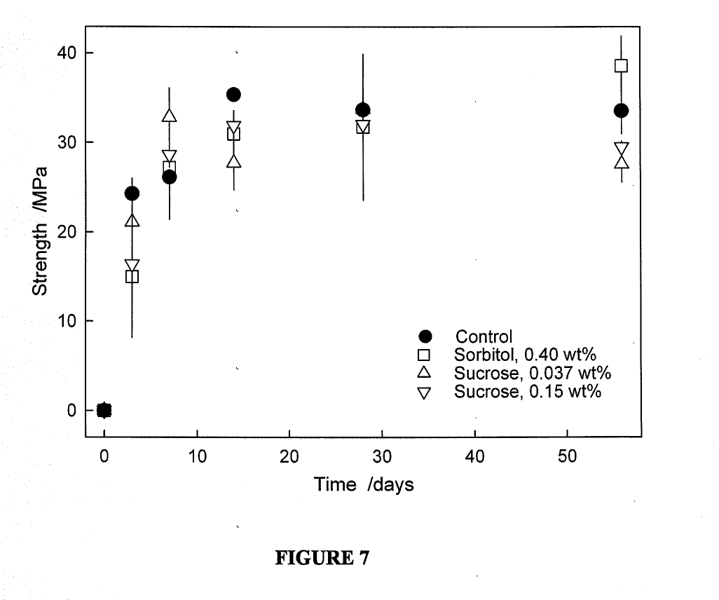

Sorbitol, a neutral six-carbon sugar alcohol, is used as a water-reducing plasticizer [16] and has been shown to act as a set retarder for OPC, although it is less potent than sucrose (0.40 wt % sorbitol induced a setting delay of two days, equivalent to the effect of 0.15 wt % sucrose [15]). Sorbitol, relative to sucrose, may provide a minor late increase in the degree of hydration (FIG. 6) and in compressive strength (FIG. 7) [15]. This effect was attributed to the ability of sorbitol, but not sucrose, to form anionic complexes with silicon and crosslinking of these complexes in the solid cement matrix [15]. Based on this, additives having a longer polyol backbone would be expected to provide further hydration and strength enhancement.

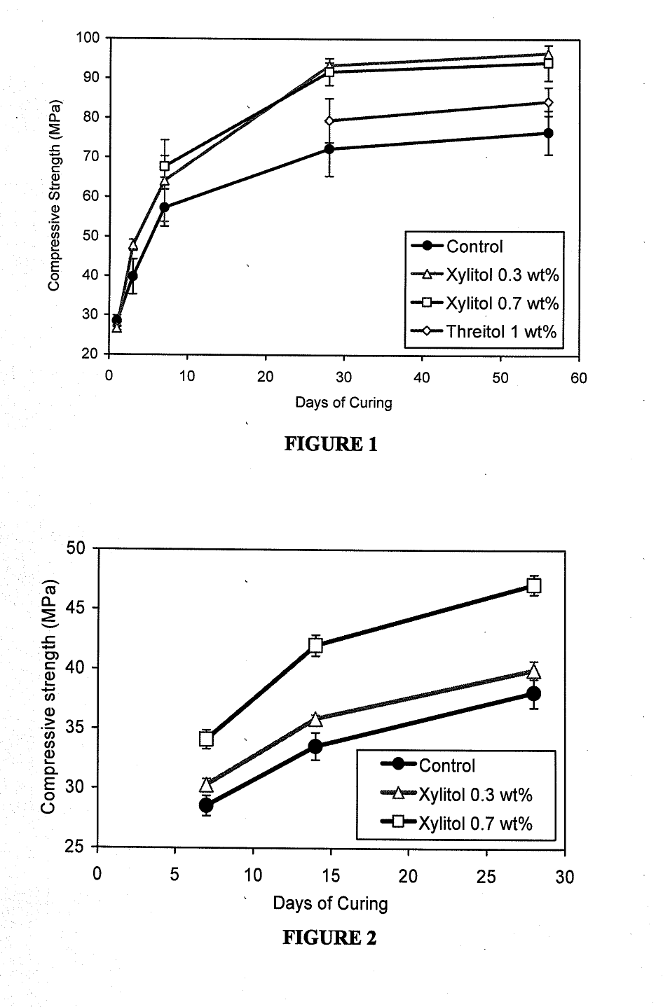

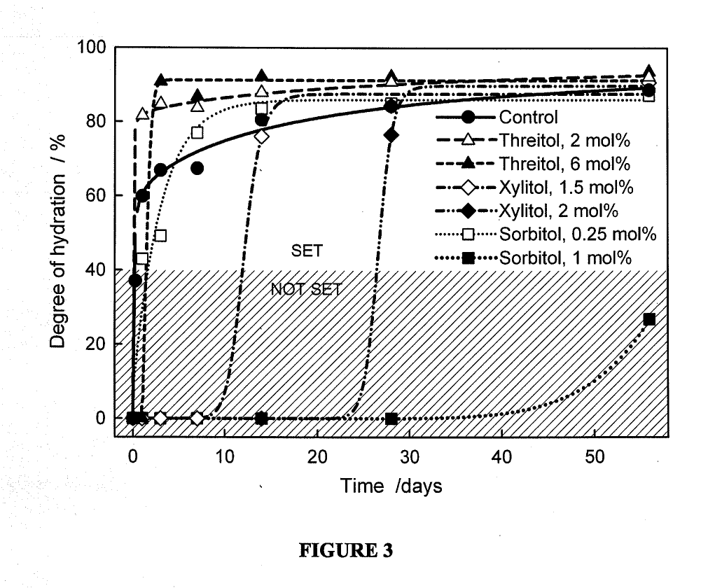

However, contrary to expectations, embodiments described herein demonstrate that additives with a shorter polyol backbone provide strength enhancement. For example, embodiments including four or five carbon sugar alcohols, and derivatives thereof, as additives for hydraulic cement, confer substantial increases in strength to the cement (FIGS. 1 and 2, and 8 to 11), and may also either retard or accelerate the setting time (FIGS. 3, 4, and 5). Moreover, the strength increase is observed in both early and late stage hydration, with increases in compressive strength of up to 26% in cement paste and 35% in concrete after 56 days of curing. The strength-enhancing effect of an additive including a four or five carbon sugar alcohol, as demonstrated herein, will exhibit the enhancement over a broad temperature range, including temperatures below 0° C. (e.g., ˜15° C., or lower). However, the strength-enhancing effect may be greater at temperatures of 0° C. and higher.

It is furthermore demonstrated by the embodiments described herein that acyclic polyol compounds including threo dihydroxy functionality (e.g., at least one threo dihydroxy pair) exhibit performance as delayed accelerators; that is, cement hydration is first inhibited and then proceeds faster than in additive-free cement. The relative effectiveness increases with the number of threo hydroxy pairs and, to a lesser extent, with the total number of hydroxy groups on the molecule.

A cement composition including an acyclic polyol compound as described herein may be used in applications such as, for example, construction of buildings, bridges, pavement, and other structures, and manufacturing, e.g., of precast/prestressed concrete products. Such use may result in less cement, concrete, mortar, etc., being required for a given application, owing to the increased strength. This would translate into reduced material cost, reduced cost of the project or manufactured item, and reduced environmental impact.

As used herein, the term “flatwork concrete” refers to concrete used for slabs, floors, driveways, sidewalks, and the like.

As used herein, the terms “frost resistant concrete” and “freeze-thaw resistant concrete” are interchangeable and refer to concrete that resists degradation resulting from freeze-thaw cycles. Concrete may be made frost resistant by entraining air into the mixture, by using either air-entraining cement or adding an air-entraining admixture. The air-entraining admixture stabilizes bubbles formed during mixing, enhances the incorporation of bubbles of various sizes by lowering the surface tension of the mixing water, impedes bubble coalescence, and anchors bubbles to cement and aggregate particles. Cement Types I, II, and III may be prepared as air-entrained cements, referred to as Types IA, IIA, and IIIA, wherein the compositions are the same as Types I, II, and III, except for the addition of a small quantity of air-entraining admixture, when such admixture is used.

All cited publications are incorporated herein by reference in their entirety.

Embodiments are further described by way of the following non-limiting examples.

### Example I

### Comparison of Strength Enhancement by Acyclic Polyol Compounds

### 1. Cement Pastes

### 1.1. Effects of Xylitol and Threitol

Type 10 ordinary portland cement (OPC) was mixed with water at water-to-cement ratio of 0.40 in a Hobart mixer. Polyols (xylitol or threitol) were added to the water prior to mixing with OPC, except in the control batch which contained no additive. The polyols were obtained from Sigma-Aldrich and were substantially pure (i.e., approx. 99%). Curing was carried out at a constant temperature of 23° C. and humidity of 100% for the first 24 hours and in double-sealed air-tight polyethylene bags at room temperature (21±1° C.) for the remainder of the curing time. Unconfined compressive strength tests were carried out in triplicate on 2-inch cubes according to ASTM C109 after various curing times (FIG. 1 and Table 8). Prior to loading, the cubes were capped with polyurethane pads and retainers (American Cube Molds, Twinsburg, Ohio) to improve the reproducibility of strength measurements.

Addition of 0.3 wt % xylitol increased the strength of cement paste by 20% (from 39.8±4.4 to 47.8±1.4 MPa) after 3 days of curing and by 26% (from 76.4±5.5 to 96.5±0.7 MPa) after 56 days of curing. This result suggests that xylitol is both an early and late stage strength enhancer. The effectiveness of xylitol remained stable when its concentration was increased from 0.3 to 0.7 wt %. Addition of 1 wt % threitol also increased strength at 28 and 56 days of curing, but the strength improvement was roughly half that obtained with xylitol.

### 1.2. Effect of Sorbitol

Type 10 ordinary portland cement was mixed with deionized water at a liquid-to-cement ratio of 0.40 in a plastic bowl. Sorbitol was added to the water prior to mixing with cement. The control batch contained no sorbitol. The mixtures were then poured into cylindrical PVC molds measuring 2 inches in diameter and 4 inches in height. Cylinders were placed in triple-sealed, air-tight polyethylene bags at room temperature (21±1° C.) to cure for periods of time ranging between 3 and 56 days. Immediately after they were removed from the molds, sample cylinders were capped top and bottom with sulfur according to ASTM C617-98 and the unconfined compressive strength was measured according to ASTM C109 in triplicate (except at day-56, for which there were seven measurements). Strength results are shown in Table 9 and FIG. 7.

Addition of sorbitol did not increase the strength of cement paste during the first 28 days of curing. At day-56, the strength increase was 15% (from 33.5±2.6 to 38.6±3.4 MPa). Hence, sorbitol is only a mild late stage strength enhancer. By contrast, xylitol already enhanced strength at day-3 and strength improvements were significantly larger than for sorbitol.

### 2. Concrete

Concrete batches were prepared by mixing Type 10 ordinary portland cement, water, dolomite coarse aggregate and screened fine aggregate (sand) in a drum mixer. The water-to-cement ratio, coarse aggregate-to-cement ratio, and fine aggregate-to-cement ratio were 0.55, 2.8 and 2.8, respectively. Xylitol was added to the water at concentrations equivalent to 0.3 wt % and 0.7 wt % of the cement content. The control batch contained no additive. The cylinders were cured in a saturated, lime water bath maintained at 23±1° C. until the strength tests. Unconfined compressive strength tests were carried out in triplicate on 4 inch×8 inch cylinders after 3, 7, and 28 days of curing (Table 10 and FIG. 2).

Addition of 0.7 wt % xylitol increased the strength of concrete by 20% (from 28.5±0.8 to 34.1±0.8 MPa) after 7 days and by 24% (from 38.1±1.3 to 47.1±0.8 MPa) after 56 days. These results show that xylitol is both an early and a late stage strength enhancer in concrete, similar to the effect observed with cement paste. The effectiveness of xylitol in concrete increased when its concentration was increased from 0.3 to 0.7 wt %.

### Example II

### Comparison of Set Retarder Effect of Sugar Alcohols and Sucrose

### Preparation of Pastes

The cements used were ASTM C 150 Type T ordinary portland cement (CEMEX, Charlevoix, Mich.) and pure tricalcium silicate (CTL Group, Skokie, Ill.). The manufacturers' specifications for each product are listed in Table 11. The additives—threitol, erythritol, adonitol, arabitol, mannitol, xylitol, sorbitol, sucrose and catechol—were obtained from Sigma-Aldrich and were substantially pure (all ≧99%).

Kilogram amounts of OPC were mixed with pre-cooled (10° C.) deionized water (18 MΩ cm) at water-to-cement mass ratio W/C=0.40 in a plastic bowl over an ice-water bath. The mixtures were stirred with a plastic spoon for about 7 min until they were homogeneous. Samples of OPC were poured into 5×10 cm PVC cylinders. They were then individually sealed in air-tight polyethylene bags (to prevent carbonation and humidity loss) and placed in a room-temperature (21±1° C.) water bath to cure for various lengths of time. For testing set times, OPC pastes were mixed in a Hobart mixer according to ASTM C305 [17].

Owing to the limited availability of C₃S, samples were prepared at W/C=0.60 [15] by combining 0.72 g water with 1.20 g cement in 8 mL polyethylene bottles, and mixing for 30 s with a glass rod. The samples were cured at 21±1° C. for various lengths of time. The entire procedure was carried out in a glove box under nitrogen in order to prevent carbonation.

Prescribed amounts of saccharide were dissolved in the mixing water of OPC and C₃S pastes. Additive concentrations are expressed as wt % of cement, and for C₃S (Ca₃SiO₅; 228.32 g mol⁻¹) also as mol % (Table 12).

### Characterization

Degree of hydration of C₃S was determined by quantitative powder X-ray diffraction (XRD) analysis [13]. After the desired curing time had elapsed (0 to 56 days), the paste was quenched in acetone, and then dried under vacuum. A representative 100 mg sample was ground, combined with 10 wt % TiO₂, and scanned at 40 kV (30 mA) on a Philips PW3710 X-ray diffractometer using Cu radiation. Data analysis was performed using Biller Diffract Plus EVA software. Extent of hydration was determined from loss in integrated area of isolated C₃S peaks at d=0.267-0.282 nm and 0.293-0.308 nm relative to that of TiO₂ peaks at 0.250 and 0.324 nm. Values exceeding 20% closely matched those obtained by the loss-on-ignition method [18-20]. Below this hydration level, XRD-based measurements fluctuated significantly and were deemed to be approximately zero.

Degree of hydration of OPC pastes was determined using the loss-on-ignition (LOT) method. About 1.0-1.5 g of crushed sample, 850-2000 μm particle size, was heated for 24 h at 105° C. to remove evaporable water and thus obtain the oven-dry weight, W₁₀₅. The fully dehydrated weight, W₁₀₀₅, was obtained after heating 2 h at 1005° C., and the degree of hydration calculated using [18, 19]:

α=(W₁₀₅−W₁₀₀₅)/(FNEW×W₁₀₀₅) (1)

where FNEW is the weight fraction of non-evaporable water in fully hydrated paste which is reported to be 0.235±0.015 for OPC [21, 22].

Time of setting of C₃S and OPC pastes was measured using a Vicat needle by ASTM C191 [23]. The initial setting time is the interval between the first contact with water and the time when Vicat needle penetration reaches 25 mm. The final setting time is reached when the needle does not leave a complete circular impression on the paste surface.

SEM-EDS analysis of C₃S and OPC pastes was performed after 1, 7, and 56 days curing. A slice (ca. 0.5 g) was taken from each sample core, immersed 24 h in acetone to halt hydration [24], dried 15 min at 105° C., and imbedded in epoxy resin. A thin-section was cut, lapped and polished (using oil-based media to avoid further hydration), carbon-coated, and then analyzed with a scanning electron microscope (JEOL JSM-5900LV) in back-scattered electron (BSE) mode in order to enhance contrast between mineral phases [25]. Elemental composition was determined using an EDS system (Oxford Link ISIS).

Unconfined compressive strength of OPC pastes was measured in accordance with ASTM C109 [26]. Immediately after they were removed from the cylindrical molds, the samples were capped top and bottom with sulfur (ASTM C617-98 [27]) and three replicate strength measurements made (except at day-56, for which there were seven measurements). The average relative standard error was ±11%, similar to that obtained from parallel measurements conducted using cubic two-inch molds.

### Results

### C₃S—Degree of Hydration and Setting Time

As illustrated in FIG. 3, the degree of hydration in additive-free C₃S paste rapidly grew to 60% within the first day of curing and increased slowly thereafter to 89% by day-56. The hydration of several saccharide-amended pastes is also depicted. The complete findings for C₃S hydration are summarized in Table 12. Addition of 1.0 wt % erythritol or adonitol had no discernible influence on curing progress, with hydration proceeding exactly as in additive-free paste. By contrast, each of the other saccharides suppressed the onset of hydration in a dose-dependent fashion. Thereafter, however, the degree of hydration rose very rapidly, with values exceeding 80% within just a few days.

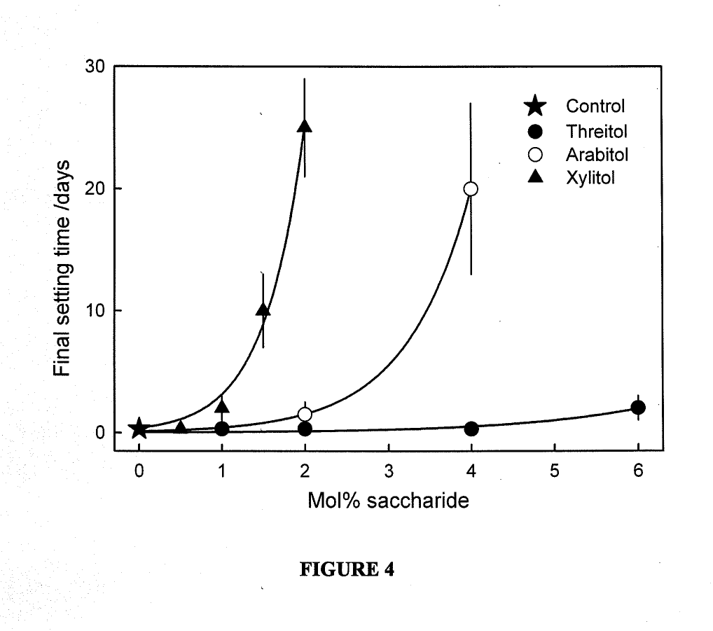

The Vicat method was used to establish whether pastes had attained a final set by 0.3, 1, 3, 7, 14, 26 and 56 days (Table 13). It was noted that all pastes with greater than 40±3% hydration were fully set, whereas those with less hydration had not. Moreover, as shown in FIG. 4, the final setting time increased exponentially with added saccharide concentration C in accordance with the function

tₛₑₜ=ae^{bC} (2)

where, for example in the case of xylitol, a=0.38±0.14 days and b=3.15±0.29 wt %⁻¹.

The relative ability of sugar alcohols to retard C₃S hydration and increase setting time can be correlated with two structural parameters: (a) foremost, the number of adjacent hydroxy groups in threo configuration; and (b) molecular size or the total number of hydroxy groups. Sugar alcohols which lack threo dihydroxy functionality—that is, erythritol and adonitol—had no discernable influence on hydration progress. Those containing a single threo pair had a small inhibitory effect which increased in accordance with molecular size: threitol<arabitol<mannitol. Xylitol and sorbitol, each with adjacent threo-threo trihydroxy functionality, were the most potent of the sugar alcohol retarders; pastes containing 1.3 wt % xylitol or 0.80 wt % sorbitol remained unset even after 56 days. The inhibitory influence of sucrose surpassed that of all the sugar alcohols, however, with as little as 0.15 wt % preventing C₃S from setting by day-56.

### C₃S Microstructure

The influence of sorbitol, the most effective of the sugar alcohol set retarders, was compared with that of sucrose on the microstructure of C₃S paste. Samples were prepared containing (a) no additive, (b) 0.40 wt % sorbitol, (c) 0.037 wt % sucrose (shown above to yield the same set delay as 0.40 wt % sorbitol), and (d) 0.15 wt % sucrose. The findings are summarized in Table 14.

At the end of day-1, the additive-free paste was fully set and contained dense islands of calcium hydroxide (CH), embedded with grains of unhydrated C₃S, in a porous matrix of C₃S and calcium silicate hydrate (CSH) gel. By day-7, the islands of CH had grown to ca. 200 μm in diameter, but otherwise had not changed in appearance. Irregularly textured CSH continued to precipitate in the surrounding matrix along with a small amount of crystalline CH, such that by day-56 the porosity of the matrix had significantly decreased.

Paste containing 0.037 wt % sucrose showed no signs of hydration after one day of curing. At day-7, now fully set, its microstructure was indistinguishable from that of the additive-free paste. No hydration was evident under SEM in pastes with 0.15 wt % sucrose over the 56 day experiment.

As noted above, C₃S containing 0.40 wt % sorbitol exhibited a similar set delay as that containing 0.037 wt % sucrose. Yet, after day-1, it displayed elongated CH crystals that were not found in the sucrose-amended paste. By day-7, these crystals had grown into islands that were twice the size of those observed in other hydrated cements. Additionally, by day-56 the surrounding matrix contained significantly more precipitated CSH and less porosity than that of other pastes.

### OPC—Setting Time

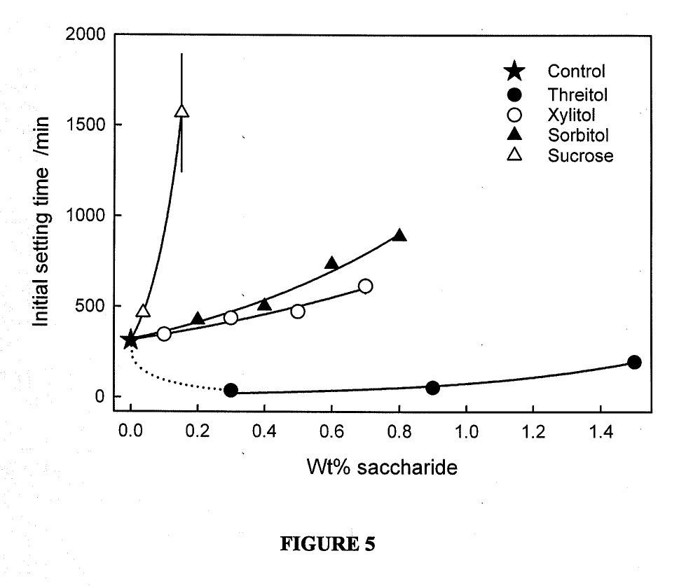

Initial and final setting times of OPC were measured as a function of added threitol, xylitol, sorbitol and sucrose (Table 6). Similar to the trend observed for C₃S, both setting times increased exponentially as saccharide concentration was increased (FIG. 5). The coefficients of best fit to equation 2 are listed in Table 15. The initial and final setting times for a given saccharide increased in similar fashion, as reflected by the equality of coefficient b. In the case of xylitol, sorbitol and sucrose, coefficient a corresponded to the additive-free setting time, whereas the magnitude of coefficient b was indicative of the relative set-retarding potency of each saccharide. As for C₃S pastes, the relative potencies increased as: xylitol<sorbitol<sucrose. The extent of retardation in each case was significantly smaller in OPC than in C₃S, although it should be noted that the water-to-cement ratios were different for the two types of paste.

Threitol was unique among the saccharides in that, rather than acting as a retarder, it caused setting to be accelerated at every concentration that was tested. The value of coefficient a, therefore, was considerably reduced. However, as for every other saccharide, setting times rose exponentially with increasing concentration of admixture. These observations are consistent with the effect observed for threitol on C₃S hydration (FIG. 3). Like the other saccharides, it appears to behave as a delayed-accelerator. However, at low concentrations especially, the retardation effect can be overwhelmed by the subsequent acceleration influence.

The final additive tested was catechol (or 1,2-dihydroxybenzene), a non-saccharide polyhydroxy molecule that is known to complex aqueous silicon under alkaline conditions [28]. The initial and final setting times with catechol, unlike those observed with the saccharides, decreased as its concentration was raised (Table 13).

### OPC—Degree of Hydration

FIG. 6 depicts degree of hydration as a function of time for OPC containing no additive, 0.037 wt % sucrose, 0.40 wt % sorbitol or 0.15 wt % sucrose. The hydration of the latter two pastes, although initially hindered, caught up with that of pure OPC by day-6. Moreover, the hydration level of sorbitol-amended paste exceeded that of the control by day-10, and remained higher through day-56 when the difference was 3.8% (at 99% confidence level by Student's T-test).

### OPC—Compressive Strength

FIG. 7 shows that the unconfined compressive strength of all OPC pastes climbed in accordance with their relative degree of hydration. The addition of either 0.15 wt % sucrose or 0.40 wt % sorbitol caused a 1-1.5 day delay in the time required for OPC to attain one-half of its normal 56-day compressive strength. By the end of the experiment, however, the sorbitol containing paste exhibited ca. 15% higher strength than additive-free OPC (i.e., 39±3 MPa and 34±3 MPa, respectively).

### OPC—Microstructure

The hydration of additive-free OPC, as compared with C₃S, yielded smaller and less distinct CH-rich islands, lower porosity, and a more complex array of hydration products, including CH, CSH, ettringite, and monosulfate. Such differences arise from portland cement's Al- and Fe-containing phases, along with the presence of alkali oxides (i.e., CaO, Na₂O, K₂O) [29]. Dense rims of CSH formed around individual grains of C₃S, growing progressively in thickness at the expense of the C₃S cores. As hydration progressed, pore spaces became increasingly filled with irregularly-textured CSH and crystalline CH.

Addition of 0.037 wt % sucrose had no effect on the microstructure of OPC paste, even though that same concentration was sufficient to prevent hydration of C₃S for at least a day. Increasing the sucrose level in OPC to 0.15 wt %, however, completely eliminated the appearance of CSH through day-1. Nonetheless, several elongated (up to several hundred μm) CH crystals were observed.

By the end of day-1, sorbitol-containing OPC showed only small crystalline masses of CH. By day-7, this paste was fully set and exhibited a microstructure that was indistinguishable from that of other OPC pastes.

The findings are summarized in Table 16.

### Discussion

Tricalcium silicate is the principal constituent of several types of cement, including OPC, and substantially pure C₃S is therefore a suitable model for studying cement hydration. The hydration of C₃S is characterized in terms of five kinetic stages [30, 31]. Stage 1 is a brief period of rapid exothermic dissolution that commences upon wetting, and abruptly ends when, according to different contending theories, cement grains become coated with a diffusion barrier of CSH gel, product nuclei are poisoned by adsorbed solution species, or progress is constrained by the slow rate of formation of stable CSH nuclei (“nucleation barrier”) [31]. During stage 2, the “induction period”, hydration occurs exceedingly slowly. The onset of stage 3 is marked by accelerated hydration and its end by the uppermost reaction rate which usually occurs within 24 h of mixing. Hydration decelerates through stage 4, and then proceeds very slowly through to completion during stage 5 (over weeks or months). Thomas [30] and Bullard [31] recently proposed quantitative models to account for the different stages.

The results show that sugar alcohols affect C₃S and OPC hydration similarly to other set retarders [10, 21], that is, they inhibit reaction progress during stage 2 and subsequently accelerate it during stage 3. This characteristic “delayed-accelerator” behavior is exemplified in FIG. 3. Their influence on setting time, which may be numerically expressed by equation 2, is therefore the net outcome of both actions. Because equation 2 does not explicitly model individual contributions of retardation and acceleration it is only valid over limited ranges in sugar concentration. Coefficient b denotes the fractional change in setting time as additive concentration is raised, and increases with the additive's retarding ability for a given value of coefficient a.

$$b = \frac{1}{{t}_{set}} \frac{d {t}_{set}}{d C} \qquad ( 3 )$$

Coefficient a provides a crude indication of the relative importance of retardation versus acceleration. Xylitol, sorbitol and sucrose, for example, only served to retard setting of OPC at the concentrations tested and, consequently, a was equal to the additive-free setting time in each case. Threitol, by contrast, proved to be a weaker retarder than an accelerator and therefore gave a value of nearly zero for a. Coefficients a and b do not vary independently, and neither can be ascribed a specific mechanistic meaning. Nonetheless, equation 2 is useful for predicting the dependence of setting times on saccharide type and concentration.

The results show that sugar alcohols which contain threo dihydroxy functionality act as delayed accelerators, their retarding ability increasing with the number of threo hydroxy pairs and, to a lesser extent, with the total number of hydroxy groups on the molecule (Tables 12 & 13, FIGS. 3 & 6). Although this trend correlates directly with the Si-binding affinity of sugar alcohols in alkaline solution [34], sucrose shows no ability to bind silicon [4] and yet is the strongest of the tested set retarders. Conversely, catechol is a complexation agent for aqueous silicon [28] but does not retard setting of OPC (Table 13). The chemical mode of action of saccharide admixtures therefore must lie elsewhere.

Having established that set retardation is independent of the admixture's ability to chelate aqueous Ca²⁺, Thomas and Birchall [4, 5] proposed that retarders poison product nucleation sites through adsorption at pendant —Ca(OH) groups. Bishop and Barron [10] also supported poisoning of CSH nuclei, but involving bidentate interaction of 1,2- or 1,3-diol groups (i.e., in accordance with Taplin [2]) to form “surface-bound oligomeric calcium alkoxides”.

Angyal [35] has reported that the metal-binding ability of monosaccharides is a function of hydroxy group configuration, and descends in the order: i) 1,3,5-triaxial triol; ii) a,e,a triol on a six-membered ring; iii) cis-cis triol on a five-membered ring; iv) acyclic threo-threo triol; v) acyclic threo diol adjacent to a primary hydroxy group; vi) acyclic erythro-threo triol; vii) acyclic erythro dial adjacent to a primary hydroxy group; viii) acyclic erythro-erythro triol; ix) cis-diol on a five-membered ring; x) cis-diol on a six-membered ring; and xi) trans-diol on a six-membered ring. This trend correlates well with the set retarding ability of sugar alcohols (configurations iv-viii) and thus is in accordance with the CSH poisoning mechanism cited above. Sucrose, a disaccharide of glucose and fructose, is more acidic (pKₐ=12.62) than sugar alcohols (pKₐ=13.5−13.8) [36] and has greater metal binding ability. Pannetier et al. [37] reported that sucrose binds Ca²⁺_{(aq)} at the C1, C3 & C4 oxygens of fructose, the C2 & C3 oxygens of glucose, and the glycosidic oxygen.

When added to OPC, sucrose and sorbitol both exhibited delayed-accelerator behavior (FIG. 6). The inhibiting influence of each saccharide on CSH precipitation was apparently stronger than on growth of crystalline CH, however, since CH was invariably the first product to appear in both types of paste (Tables 14 and 16). These early CH crystals were the precursors of dense CH-rich islands in the set cement. The fact that sucrose is a less effective set retarder for OPC than for C₃S is well known, and is generally attributed to its preferential adsorption on aluminate phases [1, 6, 9, 14]. The set retarding ability of sugar alcohols would appear to suffer a similar fate.

### Example III

### Strength Enhancement of Concrete Prepared from Cementitious Materials Including Fly Ash

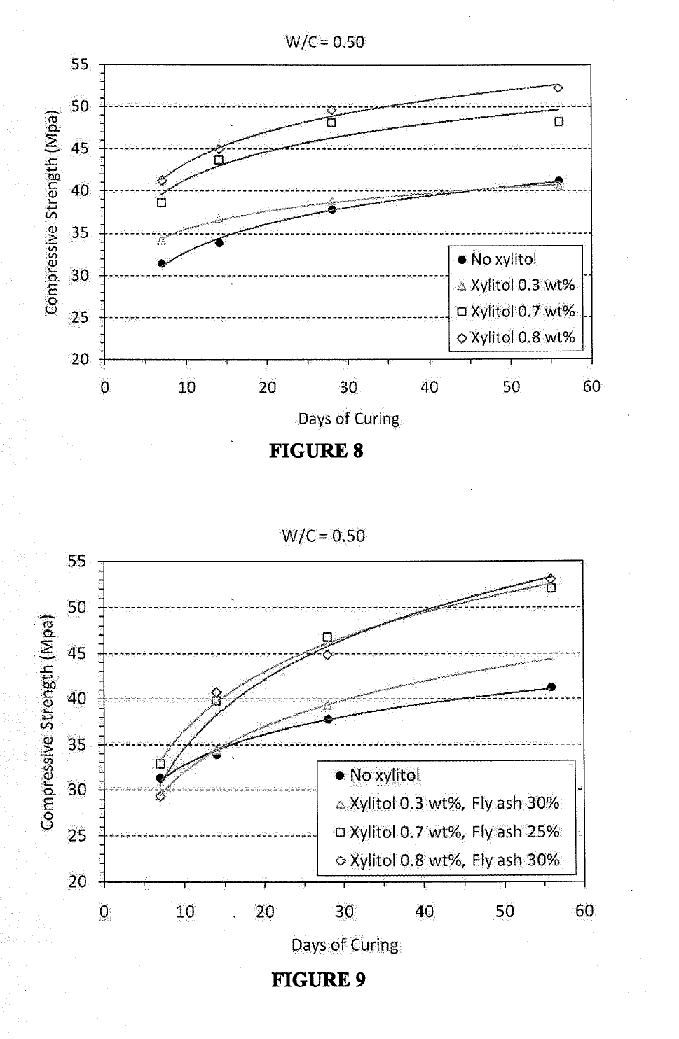

A series of concrete batches was prepared by mixing Type 10 ordinary portland cement, Type C fly ash, water, dolomite coarse aggregate and screened fine aggregate (sand) in a drum mixer. The bulk composition of the fly ash is shown in Table 17. Concrete batches were proportioned using the absolute volume method described in [38], aiming for an initial slump of 90 mm. Xylitol was added to the water at concentrations equivalent to 0.30 wt %, 0.70 wt %, and 0.80 wt % of the cementitious material (cement+fly ash) content. Proportions are reported in Table 18. Concrete cylinders were cured in a saturated lime water bath maintained at 23±1° C. until the strength tests. Unconfined compressive strength tests were carried out in triplicate on 4 in×8 in cylinders after 7, 14, 28, and 56 days of curing (Table 19 and FIGS. 8-11).

Addition of 0.8 wt % xylitol increased the strength of concrete by 27% (from 41.2±0.9 to 52.2±0.4 MPa) after 56 days in the absence of fly ash for a water-to-cement ratio equal to 0.50 (FIG. 8). When 30% of the cement was substituted by fly ash and the water-to-cement ratio was kept equal to 0.50, the addition of 0.8 wt % xylitol increased the strength of concrete by 29% (from 41.2±0.9 to 52.2±0.4 MPa) after 56 days (FIG. 9). These results show that xylitol is equally effective for increasing strength when portland cement is partially substituted by fly ash.

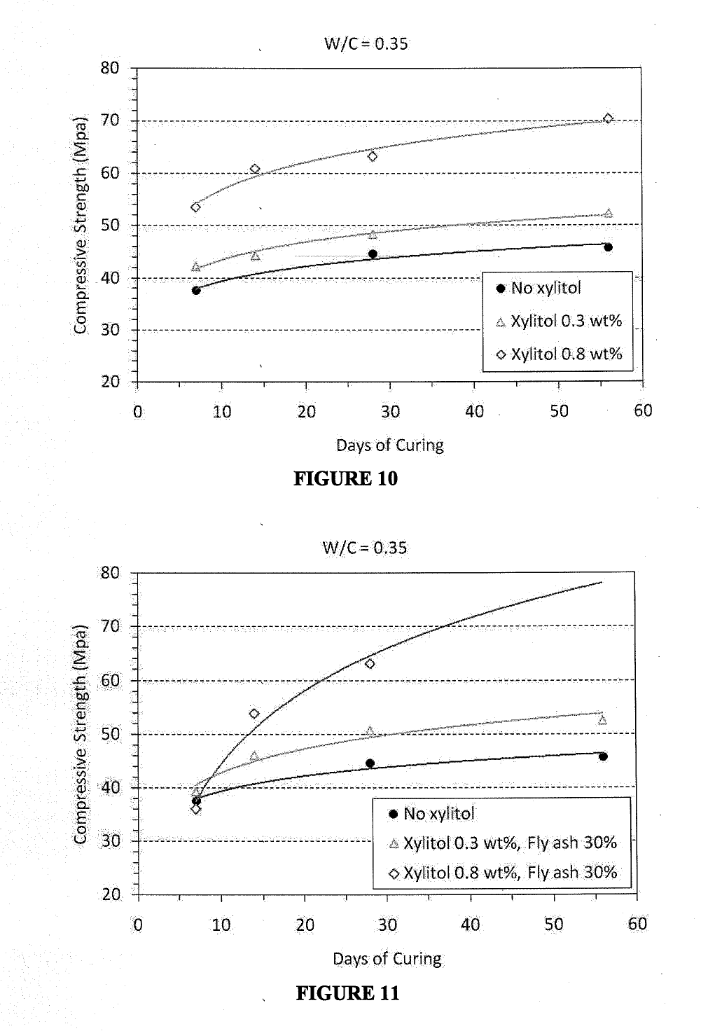

At a lower water-to-cement ratio equal to approximately 0.35, the increase in the 56-day strength due to the addition of 0.8 wt % xylitol was 35% (from 45.7±1.8 to 70.3±1.4 MPa) in the absence of fly ash (FIG. 10). When 30% of the cement was substituted by fly ash and the water-to-cementitious materials ratio was kept equal to 0.35, the addition of 0.8 wt % xylitol increased the strength of concrete by 41% (from 44.6±0.8 to 63.1±3.2 MPa) after 28 days (FIG. 11). These results demonstrate the effectiveness of xylitol as a strength enhancer over a large range of water-to-cementitious materials ratio.

### Example IV

### Strength Enhancement of Mortar Prepared from Alkali-Activated Fly Ash

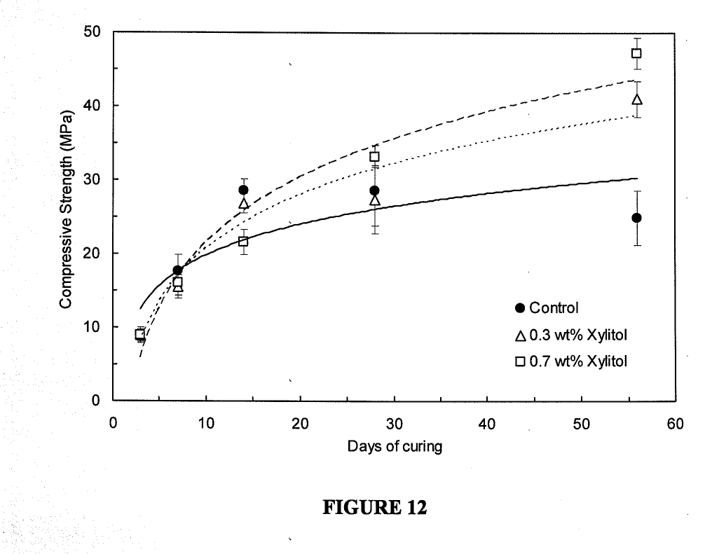

Batches of fly ash-based geopolymer mortar were prepared by combining 100.0 g Type C fly ash (bulk composition shown in Table 17), 213.0 g screened fine aggregate (sand) and an alkaline activator comprised of 42.64 g sodium silicate solution (Fisher; 26.5 wt % SiO₂, 10.6 wt % Na₂O), 6.29 g NaOH pellets (Fisher; 98 wt %) and 14.85 g deionized H₂O. Additionally, xylitol was added to the activator solution at concentrations equivalent to 0 wt %, 0.30 wt %, or 0.70 wt % of the fly ash. The mortars were blended in a Hobart mixer according to ASTM C305 [17], placed in 2 in polyethylene molds (American Cube Molds), and cured in an environmental chamber at 23±1° C. and 100% humidity for 24 hours. The cubes were then demolded and returned to the environmental chamber for the remainder of the curing time. Unconfined compressive strength tests were carried out in triplicate according to ASTM C109 after various curing times (FIG. 12). Prior to loading, the cubes were capped with polyurethane pads and retainers (American Cube Molds).

Although xylitol addition had negligible influence on the strength of geopolymer mortar after 3 days of curing (strength=8.9±1.0 MPa for all mortars tested), a dose-dependent effect was observed over longer curing periods (FIG. 12). After 56 days of curing, for example, the mortars containing 0.3 wt % and 0.7 wt % xylitol were approximately 65% and 90% stronger (with strengths of 41.0±2.4 and 47.2±2.1 MPa), respectively, than xylitol-free mortar (24.9±3.7 MPa). These results suggest that xylitol is both a mid and late stage strength enhancer of geopolymer based on Type C fly ash.

### EQUIVALENTS

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

TABLE 1
Minimum (Min) and maximum (Max) amounts of C3S, C2S, C3A, and
C4AF in various types of Portland cement (derived from [38]).

| | Amount (wt %) | | | | | | | |
|---|---|---|---|---|---|---|---|---|
| | C3S | | C2S | | C3A | | C4AF | |
| Cement | Min | Max | Min | Max | Min | Max | Min | Max |
| Type I | 45 | 65 | 6 | 21 | 6 | 12 | 6 | 11 |
| Type II | 48 | 68 | 8 | 25 | 4 | 8 | 8 | 13 |
| Type III | 48 | 66 | 8 | 27 | 2 | 12 | 4 | 13 |
| Type IV | 37 | 49 | 27 | 36 | 3 | 4 | 11 | 18 |
| Type V | 47 | 64 | 12 | 27 | 0 | 5 | 10 | 18 |
| White | 51 | 72 | 9 | 25 | 5 | 13 | 1 | 2 |

TABLE 2(a)
Minimum (Min) and maximum (Max) amounts of C₃S, C₂S, C₃A, and
C₄AF in 1 m³ flatwork concrete wherein the hydraulic cementitious
material is Type I cement, and wherein the minimum amount (280 kg)
of Type I cement is reduced by adding other material that does not
include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement | | Type I Cement | | | | | | | |
| in 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 280 | 100 | 126 | 182 | 17 | 59 | 17 | 34 | 17 | 31 |
| 252 | 90 | 113 | 164 | 15 | 53 | 15 | 30 | 15 | 28 |
| 210 | 75 | 95 | 137 | 13 | 44 | 13 | 25 | 13 | 23 |
| 182 | 65 | 82 | 118 | 11 | 38 | 11 | 22 | 11 | 20 |
| 140 | 50 | 63 | 91 | 8 | 29 | 8 | 17 | 8 | 15 |

TABLE 2(b)
Minimum (Min) and maximum (Max) amounts of C₃S, C₂S, C₃A,
and C₄AF in 1 m³ frost-resistant concrete wherein the hydraulic
cementitious material is Type I cement, and wherein the minimum
amount (335 kg) of Type I cement is reduced by adding other material
that does not include an effective amount of C₃S, C₂S,
C₃A, or C₄AF (derived from [38]).

| Min | | | | |
|---|---|---|---|---|
| Amount of | | | | |
| Cement | Type I Cement | | | |
| in 1 m³ | Amount (kg) | | | |
| Concrete | C3S | C2S | C3A | C4AF |

| (kg) | (wt %) | Min | Max | Min | Max | Min | Max | Min | Max |
|---|---|---|---|---|---|---|---|---|---|
| 335 | 100 | 151 | 218 | 20 | 70 | 20 | 40 | 20 | 37 |
| 302 | 90 | 136 | 196 | 18 | 63 | 18 | 36 | 18 | 33 |
| 251 | 75 | 113 | 163 | 15 | 53 | 15 | 30 | 15 | 28 |
| 218 | 65 | 98 | 142 | 13 | 46 | 13 | 26 | 13 | 24 |
| 168 | 50 | 75 | 109 | 10 | 35 | 10 | 20 | 10 | 18 |

TABLE 3(a)
Minimum (Min) and maximum (Max) amounts of C₃S, C₂S, C₃A,
and C₄AF in 1 m³ flatwork concrete wherein the hydraulic
cementitious material is Type II cement, and wherein the minimum
amount (280 kg) of Type II cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement in | | Type II Cement | | | | | | | |
| 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 280 | 100 | 134 | 190 | 22 | 70 | 11 | 22 | 22 | 36 |
| 252 | 90 | 121 | 171 | 20 | 63 | 10 | 20 | 20 | 33 |
| 210 | 75 | 101 | 143 | 17 | 53 | 8 | 17 | 17 | 27 |
| 182 | 65 | 87 | 124 | 15 | 46 | 7 | 15 | 15 | 24 |
| 140 | 50 | 67 | 95 | 11 | 35 | 6 | 11 | 11 | 18 |

TABLE 3(b)
Minimum (Min) and maximum (Max) amounts of C₃S, C₂S, C₃A,
and C₄AF in 1 m³ frost-resistant concrete wherein the hydraulic
cementitious material is Type II cement, and wherein the minimum
amount (280 kg) of Type II cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement in | | Type II Cement | | | | | | | |
| 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 335 | 100 | 161 | 228 | 27 | 84 | 13 | 27 | 27 | 44 |
| 302 | 90 | 145 | 205 | 24 | 75 | 12 | 24 | 24 | 39 |
| 251 | 75 | 121 | 171 | 20 | 63 | 10 | 20 | 20 | 33 |
| 218 | 65 | 105 | 148 | 17 | 54 | 9 | 17 | 17 | 28 |
| 168 | 50 | 80 | 114 | 13 | 42 | 7 | 13 | 13 | 22 |

TABLE 4(a)
Minimum (Min) and maximum (Max) amounts of C₃S, C₂S, C₃A,
and C₄AF in 1 m³ flatwork concrete wherein the hydraulic
cementitious material is Type III cement, and wherein the minimum
amount (280 kg) of Type III cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement | | Type III Cement | | | | | | | |
| in 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 280 | 100 | 134 | 185 | 22 | 76 | 6 | 34 | 11 | 36 |
| 252 | 90 | 121 | 166 | 20 | 68 | 5 | 30 | 10 | 33 |
| 210 | 75 | 101 | 139 | 17 | 57 | 4 | 25 | 8 | 27 |
| 182 | 65 | 87 | 120 | 15 | 49 | 4 | 22 | 7 | 24 |
| 140 | 50 | 67 | 92 | 11 | 38 | 3 | 17 | 6 | 18 |

TABLE 4(b)
Minimum (Min) and maximum (Max) amounts of C₃S, C₂S, C₃A,
and C₄AF in 1 m³ frost-resistant concrete wherein the hydraulic
cementitious material is Type III cement, and wherein the minimum
amount (335 kg) of Type III cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement | | Type III Cement | | | | | | | |
| in 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 335 | 100 | 161 | 221 | 27 | 90 | 7 | 40 | 13 | 44 |
| 302 | 90 | 145 | 199 | 24 | 81 | 6 | 36 | 12 | 39 |
| 251 | 75 | 121 | 166 | 20 | 68 | 5 | 30 | 10 | 33 |
| 218 | 65 | 105 | 144 | 17 | 59 | 4 | 26 | 9 | 28 |
| 168 | 50 | 80 | 111 | 13 | 45 | 3 | 20 | 7 | 22 |

TABLE 5(a)
Minimum (Min) and maximum (Max) amounts of C₃S, C₂S, C₃A,
and C₄AF in 1 m³ flatwork concrete wherein the hydraulic
cementitious material is Type IV cement, and wherein the minimum
amount (280 kg) of Type IV cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement in | | Type IV Cement | | | | | | | |
| 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 280 | 100 | 104 | 137 | 76 | 101 | 8 | 11 | 31 | 50 |
| 252 | 90 | 93 | 123 | 68 | 91 | 8 | 10 | 28 | 45 |
| 210 | 75 | 78 | 103 | 57 | 76 | 6 | 8 | 23 | 38 |
| 182 | 65 | 67 | 89 | 49 | 66 | 5 | 7 | 20 | 33 |
| 140 | 50 | 52 | 69 | 38 | 50 | 4 | 6 | 15 | 25 |

TABLE 5(b)
Minimum (Min) and maximum (Max) amounts of C₃S, C₂S, C₃A,
and C₄AF in 1 m³ frost-resistant concrete wherein the hydraulic
cementitious material is Type IV cement, and wherein the minimum
amount (335 kg) of Type IV cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement in | | Type IV Cement | | | | | | | |
| 1 m³ | | Amount (kg) | | | | | | | |
| Concrete | | C3S | | C2S | | C3A | | C4AF | |
| (kg) | (%) | Min | Max | Min | Max | Min | Max | Min | Max |
| 335 | 100 | 124 | 164 | 90 | 121 | 10 | 13 | 37 | 60 |
| 302 | 90 | 112 | 148 | 81 | 109 | 9 | 12 | 33 | 54 |
| 251 | 75 | 93 | 123 | 68 | 90 | 8 | 10 | 28 | 45 |
| 218 | 65 | 81 | 107 | 59 | 78 | 7 | 9 | 24 | 39 |
| 168 | 50 | 62 | 82 | 45 | 60 | 5 | 7 | 18 | 30 |

TABLE 6(a)
Minimum (Min) and maximum (Max) amounts of C₃S, C₂S, C₃A,
and C₄AF in 1 m³ flatwork concrete wherein the hydraulic
cementitious material is Type V cement, and wherein the minimum
amount (280 kg) of Type V cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement | | Type V Cement | | | | | | | |
| in 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 280 | 100 | 132 | 179 | 34 | 76 | 0 | 14 | 28 | 50 |
| 252 | 90 | 118 | 161 | 30 | 68 | 0 | 13 | 25 | 45 |
| 210 | 75 | 99 | 134 | 25 | 57 | 0 | 11 | 21 | 38 |
| 182 | 65 | 86 | 116 | 22 | 49 | 0 | 9 | 18 | 33 |
| 140 | 50 | 66 | 90 | 17 | 38 | 0 | 7 | 14 | 25 |

TABLE 6(b)
Minimum (Min) and maximum (Max) amounts of C₃S, C₂S, C₃A,
and C₄AF in 1 m³ frost-resistant concrete wherein the hydraulic
cementitious material is Type V cement, and wherein the minimum
amount (335 kg) of Type V cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement in | | Type V Cement | | | | | | | |
| 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 335 | 100 | 157 | 214 | 40 | 90 | 0 | 17 | 34 | 60 |
| 302 | 90 | 142 | 193 | 36 | 81 | 0 | 15 | 30 | 54 |
| 251 | 75 | 118 | 161 | 30 | 68 | 0 | 13 | 25 | 45 |
| 218 | 65 | 102 | 139 | 26 | 59 | 0 | 11 | 22 | 39 |
| 168 | 50 | 79 | 107 | 20 | 45 | 0 | 8 | 17 | 30 |

TABLE 7(a)
Minimum (Min) and maximum (Max) amounts of C₃S, C₂S, C₃A,
and C₄AF in 1 m³ flatwork concrete wherein the hydraulic
cementitious material is white cement, and wherein the minimum amount
(280 kg) of Type IV cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement in | | White Cement | | | | | | | |
| 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 280 | 100 | 143 | 202 | 25 | 70 | 14 | 36 | 3 | 6 |
| 252 | 90 | 129 | 181 | 23 | 63 | 13 | 33 | 3 | 5 |
| 210 | 75 | 107 | 151 | 19 | 53 | 11 | 27 | 2 | 4 |
| 182 | 65 | 93 | 131 | 16 | 46 | 9 | 24 | 2 | 4 |
| 140 | 50 | 71 | 101 | 13 | 35 | 7 | 18 | 1 | 3 |

TABLE 7(b)
Minimum (Min) and maximum (Max) amounts of C₃S, C₂S, C₃A,
and C₄AF in 1 m³ frost-resistant concrete wherein the hydraulic
cementitious material is white cement, and wherein the minimum
amount (335 kg) of white cement is reduced by adding other material
that does not include an effective amount of C₃S, C₂S, C₃A, or
C₄AF (derived from [38]).

| Min | | | | | | | | | |
|---|---|---|---|---|---|---|---|---|---|
| Amount of | | | | | | | | | |
| Cement in | | White Cement | | | | | | | |
| 1 m³ | | Amount (kg) | | | | | | | |
| Concrete | | C3S | | C2S | | C3A | | C4AF | |
| (kg) | (wt %) | Min | Max | Min | Max | Min | Max | Min | Max |
| 335 | 100 | 171 | 241 | 30 | 84 | 17 | 44 | 3 | 7 |
| 302 | 90 | 154 | 217 | 27 | 75 | 15 | 39 | 3 | 6 |
| 251 | 75 | 128 | 181 | 23 | 63 | 13 | 33 | 3 | 5 |
| 218 | 65 | 111 | 157 | 20 | 54 | 11 | 28 | 2 | 4 |
| 168 | 50 | 85 | 121 | 15 | 42 | 8 | 22 | 2 | 3 |

TABLE 8
Compressive strength results for cement
pastes containing xylitol or threitol.

| | Compressive Strength (MPa) | | | |
|---|---|---|---|---|
| | | Xylitol 0.3 | Xylitol 0.7 | Threitol 1.0 |
| Time (d) | Control | wt. % ^{a} | wt. % ^{a} | wt. % ^{a} |
| 1 | 28.5 ± 1.4 | 26.7 ± 0.6 | ^{b} | ^{b} |
| 3 | 39.8 ± 4.4 | 47.8 ± 1.4 | ^{b} | ^{b} |
| 7 | 57.3 ± 4.7 | 64.0 ± 10.3 | 67.6 ± 2.7 | ^{b} |
| 28 | 72.2 ± 6.9 | 93.3 ± 1.7 | 91.7 ± 3.4 | 79.4 ± 5.6 |
| 56 | 76.4 ± 5.5 | 96.5 ± 0.7 | 94.1 ± 4.5 | 84.2 ± 3.6 |

^{a} Additive concentrations are given in weight percent of cement.
^{b} No data.

TABLE 9
Compressive strength results for cement pastes containing sorbitol.

Compressive Strength (MPa)

| | | Sorbitol 0.4 |
|---|---|---|
| Time (d) | Control | wt %^{a} |
| 3 | 24.3 ± 1.7 | 15.0 ± 0.9 |
| 7 | 26.2 ± 4.7 | 27.2 ± 0.9 |
| 14 | 35.4 ± 0.3 | 31.0 ± 1.2 |
| 28 | 33.7 ± 4.1 | 31.8 ± 8.1 |
| 56 | 33.5 ± 2.6 | 38.6 ± 3.4 |

^{a}Sorbitol concentration is given in weight percent of cement.

TABLE 10
Compressive strength results for concrete
cylinders containing xylitol.

| | Compressive Strength (MPa) | | |
|---|---|---|---|
| | | Xylitol 0.3 | Xylitol 0.7 |
| Time (d) | Control | wt. %^{a} | wt. %^{a} |
| 7 | 28.5 ± 0.8 | 30.3 ± 0.5 | 34.1 ± 0.8 |
| 14 | 33.5 ± 1.1 | 35.8 ± 0.3 | 42.0 ± 0.9 |
| 28 | 38.1 ± 1.3 | 40.0 ± 0.7 | 47.1 ± 0.8 |

^{a}Xylitol concentrations are given in weight percent of cement.

TABLE 11
Characteristics of unhydrated OPC and C₃S.

| Property | OPC | C₃S^{a} |
|---|---|---|
| Chemical composition (wt %) | | |
| SiO₂ | 19.4 | 26.3 |
| Al₂O₃ | 5.16 | Traces |
| Fe₂O₃ | 2.47 | 0 |
| CaO | 62.6 | 73.7 |
| MgO | 3.48 | Traces |
| SO₃ | 3.57 | 0 |
| Phase composition (wt %) | | |
| C₃S | 60 | 100 |
| C₂S | 11 | 0 |
| C₃A | 10 | 0 |
| C₄AF | 8 | 0 |
| Loss-on-ignition (wt %) | 1.52 | — |
| Insoluble residue (wt %) | 0.15 | — |
| Alkalies as Na₂O (wt %) | 0.85 | 0 |
| Specific surface area (m²/kg) | 328 | 94 |

^{a}Crystallographically-pure triclinic alite.

TABLE 12
Effect of saccharide additives on hydration of C₃S paste (W/C = 0.6, T = 21 ± 1° C.)

| | | Concentration | | Days to reach 40% |
|---|---|---|---|---|
| Additive | | /mol % | /wt % | hydration |
| — | | — | — | 0.3 |
| erythritol (0)^{a} | 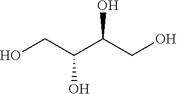 | 1.9 | 1.0 | 0.3^{b} |
| adonitol (0) | 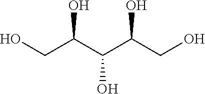 | 1.5 | 1.0 | 0.3^{b} |
| threitol (1) | 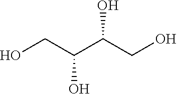 | 2.0 4.0 6.0 | 1.1 2.1 3.2 | <0.3^{b} <0.3^{c} 1.5^{c} |
| arabitol (1) | 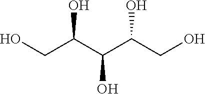 | 2.0 4.0 6.0 | 1.3 2.7 4.0 | 1.5^{c} ca. 20 >56 |
| mannitol (1) | 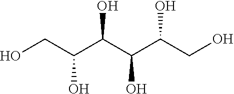 | 1.3 | 1.0 | 2 |
| xylitol (2) | 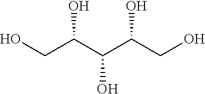 | 0.50 1.0 1.5 2.0 | 0.33 0.67 1.0 1.3 | <0.3 2^{c} ca. 10 ca. 20 |
| sorbitol (2) | 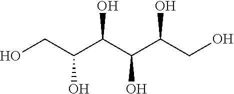 | 0.25 0.50 1.0 | 0.20 0.40 0.80 | 0.5^{d} 2^{d} >56 |
| sucrose | 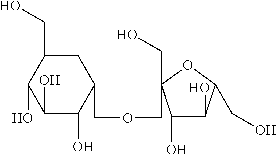 | 0.025 0.10 | 0.037 0.15 | 2^{d} >56 |

^{a}Number of threo dihydroxy pairs on the sugar alcohol.
^{b}Negligible effect over the entire curing period.
^{c}80% degree of hydration reached by day-3 (the control attained 80% hydration by day-14.)
^{d}80% hydration reached by day-7.

TABLE 13
Summary of the effect of saccharide additives
on the final set times of C₃S and OPC.

| | |
|---|---|
| Concentration/ | Final set time/days |

| Additive | wt % | C₃S ^{a} | OPC ^{b} |
|---|---|---|---|
| — | — | 0.3-1 | 0.25 ± 0.01 |
| adonitol | 1.0 | <1 | ^{c} |
| threitol | 0.30 | ^{c} | 0.040 ± 0.002 |
| | 0.90 | ^{c} | 0.049 ± 0.003 |
| | 1.1 | <1 | ^{c} |
| | 1.5 | ^{c} | 0.18 ± 0.01 |
| | 2.1 | <1 | ^{c} |
| | 3.2 | 1-3 | ^{c} |
| arabitol | 1.3 | 1-3 | |
| | 2.7 | 14-28 | ^{c} |
| | 4.0 | >56 | |
| xylitol | 0.10 | ^{c} | 0.27 ± 0.02 |
| | 0.30 | ^{c} | 0.35 ± 0.01 |
| | 0.33 | <1 | ^{c} |
| | 0.67 | 1-3 | ^{c} |
| | 0.70 | ^{c} | 0.54 ± 0.05 |
| | 1.0 | 7-14 | ^{c} |
| | 1.3 | 14-28 | 1.57 ± 0.01 |
| sorbitol | 0.20 | <1 | 0.33 ± 0.01 |
| | 0.40 | 1-3 | 0.372 ± 0.003 |
| | 0.60 | ^{c} | 0.58 ± 0.01 |
| | 0.80 | >56 | 0.68 ± 0.01 |
| sucrose | 0.037 | 1-3 | 0.354 ± 0.003 |
| | 0.15 | >56 | 1.5 ± 0.3 |
| catechol | 0.050 | ^{c} | 0.229 ± 0.007 |
| | 0.10 | ^{c} | 0.194 ± 0.004 |

^{a} W/C = 0.6, T = 21 ± 1° C.; final set evaluated only at 0.3, 1, 3, 7, 14, 28 and 56 days.
^{b} W/C = 0.4, T = 23 ± 1° C.
^{c} No data.

TABLE 14
Status of C₃S pastes after 1, 7 and 56 days curing at 21 ± 1° C.

| Additive | Day-1 | Day-7 | Day-56 |
|---|---|---|---|
| — | Set; | Set; | Set; |
| | CH-rich islands (100- | CH-rich islands (~200 | CH-rich islands in |
| | 150 μm) in porous CSH | μm) in porous CSH | slightly porous CSH |
| | matrix | matrix | matrix |
| 0.037 wt % | No hydration | Set; | Set; |
| sucrose | | CH-rich islands (100- | CH-rich islands in |
| | | 200 μm) in porous CSH | slightly porous CSH |
| | | matrix | matrix |
| 0.15 wt % | No hydration | No hydration | No hydration |
| sucrose | | | |
| 0.40 wt % | Not set; | Set; | Set; |
| sorbitol | elongated CH crystals | CH-rich islands (300- | CH-rich islands in non- |
| | | 400 μm) in porous CSH | porous CSH matrix |
| | | matrix | |

TABLE 15
Exponential dependence of the initial and final
setting times of OPC paste on saccharide concentration, C (in
wt %),^{a} expressed as tₛₑₜ = a e^{bC}.

| Additive | Set point | ^{a}/min | ^{b}/wt %⁻¹ |
|---|---|---|---|
| threitol | Initial | 12.1 ± 7.2 | 1.85 ± 0.41 |
| | Final | 18 ± 14 | 1.76 ± 0.54 |
| xylitol | Initial | 314 ± 13 | 0.93 ± 0.08 |
| | Final | 348 ± 27 | 1.09 ± 0.15 |
| sorbitol | Initial | 318 ± 20 | 1.31 ± 0.10 |
| | Final | 354 ± 33 | 1.30 ± 0.15 |
| sucrose | Initial | 312 ± 1 | 10.8 ± 1.0 |
| | Final | 332 ± 19 | 12.6 ± 4.0 |

^{a}Determined at W/C = 0.4 and T = 23 ± 1° C. using saccharide concentrations ranging up to 1.5 wt % for threitol, 0.7 wt % for xylitol, 0.8 wt % for sorbitol and 0.15 wt % for sucrose.

TABLE 16
Status of OPC pastes after 1, 7 and 56 days curing at 21 ± 1° C.

| OPC Paste | Day-1 | Day-7 | Day-56 |
|---|---|---|---|
| Control | Set; | Set; | Set; |
| | C₃S grains rimmed | thick CSH rims on C₃S | very thick CSH rims on |
| | with CSH; small CH- | grains; reduced matrix | remaining C₃S grains; |
| | rich islands (<100 μm) | porosity | little porosity |
| | in complex matrix of | | |
| | CSH, CH and other | | |
| | hydration products | | |
| | [ | | |
| 0.037 wt % | Set; | Set; | Set; |
| sucrose | similar to pure OPC at | similar to pure OPC at | similar to pure OPC at |
| | day-1 | day-7 | day-56 |
| 0.15 wt % | Not set; | Set; | Set; |
| sucrose | some CH crystals | similar to pure OPC at | similar to pure OPC at |
| | | day-7 | day-56 |
| 0.40 wt % | Not set; | Set; | Set; |
| sorbitol | some CH crystals | similar to pure OPC at | similar to pure OPC at |
| | | day-7 | day-56 |

TABLE 17
Bulk composition of fly ash.

| Oxide | wt % |
|---|---|
| Total | 96.3 |
| SiO₂ | 43.0 |
| Al₂O₃ | 21.0 |
| Fe₂O₃ | 4.2 |
| MgO | 2.60 |
| CaO | 14.5 |
| Na₂O | 7.50 |
| K₂O | 0.60 |
| TiO₂ | 0.90 |
| P₂O₅ | 0.60 |
| MnO | 0.02 |
| Cr₂O₃ | <0.01 |
| V₂O₅ | 0.02 |
| S | 0.62 |
| LOI | 0.8 |

TABLE 18
Proportioning of concrete batches prepared from cementitious material including
fly ash.

| | | | | Dry | | | | |
|---|---|---|---|---|---|---|---|---|
| | | Fly | | Coarse | Dry Fine | | | Fly Ash |
| | Cement | Ash | Water^{a} | Aggregate | Aggregate | Xylitol^{b} | | Substitution |
| Batch | (kg) | (kg) | (kg) | (kg) | (kg) | (wt %) | W/C^{c} | Fraction^{d} |
| 1 | 17.49 | — | 8.74 | 58.72 | 45.81 | — | 0.500 | — |
| 2 | 21.60 | — | 10.79 | 66.47 | 47.79 | 0.30 | 0.500 | — |
| 3 | 19.20 | — | 9.35 | 66.56 | 52.88 | 0.70 | 0.487 | — |
| 4 | 21.60 | — | 10.87 | 66.41 | 47.57 | 0.80 | 0.503 | — |
| 5 | 14.28 | 6.12 | 10.32 | 66.45 | 50.33 | 0.30 | 0.506 | 0.30 |
| 6 | 14.40 | 4.80 | 9.42 | 66.52 | 52.86 | 0.70 | 0.491 | 0.25 |
| 7 | 12.61 | 5.41 | 9.11 | 58.69 | 44.32 | 0.80 | 0.506 | 0.30 |
| 8 | 34.29 | — | 13.00 | 66.48 | 33.73 | — | 0.379 | — |
| 9 | 36.00 | — | 12.67 | 66.41 | 30.44 | 0.30 | 0.352 | — |
| 10 | 28.01 | — | 9.81 | 58.72 | 33.50 | 0.80 | 0.350 | — |
| 11 | 19.61 | 8.40 | 9.89 | 58.69 | 33.71 | 0.30 | 0.353 | 0.30 |
| 13 | 24.00 | 10.29 | 12.09 | 66.45 | 33.18 | 0.80 | 0.353 | 0.30 |

^{a}Water includes fine and coarse aggregate moistures.
^{b}Xylitol concentration is given in weight percent of cement.
^{c}Water to cementitious materials ratio
^{d}(Fly ash mass)/(Cement mass + Fly ash mass)

TABLE 19
Compressive strength results for concrete batches prepared from cementitious
material including fly ash.

| | | | Fly Ash | 7-day | 14-day | 28-day | 56-day |
|---|---|---|---|---|---|---|---|
| | Xylitol^{a} | | Substitution | strength | strength | strength | strength |
| Run | (wt %) | W/C^{b} | Fraction^{c} | (MPa) | (MPa) | (MPa) | (MPa) |
| 1 | — | 0.500 | — | 31.4 ± 1.0 | 33.9 ± 0.6 | 37.8 ± 0.6 | 41.2 ± 0.9 |
| 2 | 0.30 | 0.500 | — | 34.2 ± 1.7 | 36.7 ± 1.0 | 38.9 ± 1.0 | 40.6 ± 0.6 |
| 3 | 0.70 | 0.487 | — | 38.6 ± 0.8 | 43.7 ± 2.3 | 48.2 ± 0.9 | 48.2 ± 0.2 |
| 4 | 0.80 | 0.503 | — | 41.3 ± 0.8 | 45.0 ± 0.5 | 49.6 ± 0.5 | 52.2 ± 0.4 |
| 5 | 0.30 | 0.506 | 0.30 | 29.5 ± 1.6 | 34.5 ± 0.5 | 39.4 ± 0.5 | |
| 6 | 0.70 | 0.491 | 0.25 | 32.9 ± 0.1 | 39.8 ± 0.3 | 46.8 ± 1.1 | 52.0 ± 1.9 |
| 7 | 0.80 | 0.506 | 0.30 | 29.4 ± 1.4 | 40.8 ± 0.03 | 44.8 ± 1.6 | 53.1 ± 2.0 |
| 8 | — | 0.379 | — | 37.6 ± 4.1 | | 44.6 ± 0.8 | 45.7 ± 1.8 |
| 9 | 0.30 | 0.352 | — | 42.2 ± 1.4 | 44.3 ± 1.7 | 48.4 ± 1.5 | 52.3 ± 1.9 |
| 10 | 0.80 | 0.350 | — | 53.5 ± 1.2 | 60.9 ± 1.5 | 63.2 ± 0.9 | 70.3 ± 1.4 |
| 11 | 0.30 | 0.353 | 0.30 | 39.3 ± 1.4 | 46.1 ± 0.7 | 50.7 ± 0.7 | 52.5 ± 0.3 |
| 13 | 0.80 | 0.353 | 0.30 | 36.0 ± 3.4 | 53.8 ± 1.0 | 63.1 ± 3.2 | |

^{a}Xylitol concentration is given in weight percent of cement.
^{b}Water to cementitious materials ratio
^{c}(Fly ash mass)/(Cement mass + Fly ash mass)

### REFERENCES

[1] V. S. Ramachandran, M. S. Lowery, “Conduction calorimetric investigation of the effect of retarders on the hydration of Portland cement,” Thermochim. Acta, 195, 373-387 (1992).
[2] J. H. Taplin, “Some chemical additions and admixtures in cement paste and concrete,” Proc. 4^{th} Inter. Congr. Chem. Cem., Washington, vol. VII, 924-925 (1960).
[4] J. F. Young, “A review of the mechanisms of set-retardation in portland cement pastes containing organic admixtures,” Cem. Coner. Res., 2, 415-433 (1972).
[5] N. L. Thomas, J. D. Birchall, “The retardation action of sugars on cement hydration,” Cem. Coner. Res., 13, 830-842 (1983).
[6] J. D. Birchall, N. L. Thomas, “The mechanism of retardation of setting of OPC by sugars,” Br. Ceram. Proc., 35, 305-315 (1984).
[9] K. Luke, G. Luke, “Effect of sucrose on retardation of Portland cement,” Adv. Cem. Res., 12, 9-18 (2000).
[10] M. Bishop, A. R. Barron, “Cement hydration inhibition with sucrose, tartaric acid, and lignosulfonate: analytical and spectroscopic study,” Ind. Eng. Chem. Res., 45, 7042-7049 (2006).
[13] N. B. Milestone, “Hydration of tricalcium silicate in the presence of lignosulfonates, glucose, and sodium gluconate,”J. Am. Ceram. Soc., 62, 321-324 (1979).
[14] H. M. Jennings, H. Taleb, G. Frohnsdorff, J. R. Clifton, “Interpretation of the effects of retarding admixtures on pastes of C₃S, C₃A plus gypsum, and portland cement,” Proc. 8^{th} Inter. Congr. Chem. Cem., Rio de Janeiro, vol. III, 239-243 (1986).
[15] L. Zhang, L. J. J. Catalan, A. C. Larsen, S. D. Kinrade, “Effects of sucrose and sorbitol on cement-based stabilization/solidification of toxic metal waste,” J. Hazard. Mat., 151, 490-498 (2008).
[16] A. M. Cody, H. Lee, R. D. Cody, P. G. Spry, The effects of chemical environment on the nucleation, growth, and stability of ettringite [Ca₃Al(OH)₆]₂(SO₄)₃.26H₂O,” Cem. Concr. Res., 34, 869-881 (2004).
[17] Standard practice for mechanical mixing of hydraulic cement pastes and mortars of plastic consistency, ASTM C305-06 (2006).
[18] L. J. Parrott, M. Geiker, W. A. Gutteridge, and D. Killoh, “Monitoring Portland cement hydration: Comparison of methods,” Cem. Concr. Res., 20, 919-926 (1990).
[19] L. E. Copeland and J. C. Hayes, “Determination of non-evaporable water in hardened portland-cement paste,” ASTM Bulletin, No. 194, pp. 70-74 (1953).
[20] M. C. G. Juenger and H. M. Jennings, “Examining the relationship between the microstructure of calcium silicate hydrate and drying shrinkage of cement pastes,” Cem. Concr. Res., 32, 289-296 (2002).
[21] H. F. W. Taylor, Cement Chemistry, Academic Press, San Diego, Calif. (1990).
[22] Design and control of concrete mixtures, seventh Canadian edition, Cement Association of Canada, Ottawa, ON (2002).
[23] Standard test methods for time of setting of hydraulic cement by Vicat needle, ASTM C191-08 (2008).
[24] K. O. Kjellsen, R. J. Detwiler, and O. E. Gjorv, “Backscattered electron image analysis of cement paste specimens: specimen preparation and analytical methods,” Cem. Concr. Res., 21, 388-390 (1991).
[25] K. L. Scrivener, “Backscattered electron imaging of cementitious microstructures: understanding and quantification,” Cem. Concr. Composites, 26, 935-945 (2004).
[26] Standard test method for compressive strength of hydraulic cement mortars (using 2-in. or [50-mm] cube specimens), ASTM C109/C109M-98 (1998).
[27] Standard practice for capping cylindrical concrete specimens, ASTM C617-98 (2003).
[28] I. F. Sedeh, S. Sjöberg, L. O. Öhman, “Equilibrium and structural studies of silicon (IV) and aluminum (III) in aqueous solution. 30. Aqueous complexation between silicic acid and some ortho-, di- and triphenolic compounds,” Acta Chem. Scand. 46, 933-940 (1992).
[29] L. Mentink. Use of particular polysaccharides as admixtures for mineral materials, U.S. Pat. Appl. 20060054062 (2006).
[30] J. J. Thomas, “A new approach to modeling the nucleation and growth kinetics of tricalcium silicate hydration,” J. Am. Ceram. Soc., 90, 3282-3288 (2007).
[31] J. W. Bullard, “A determination of hydration mechanisms for tricalcium silicate using a kinetic cellular automaton model,” J. Am. Ceram. Soc., 91, 2088-2097 (2008).
[34] S. D. Kinrade, J. W. Del Nin, A. S. Schach, T. A. Sloan, K. L. Wilson, C. T. G. Knight, “Stable five- and six-coordinated silicate anions in aqueous solution,” Science, 285, 1542-1545 (1999).
[35] S. J. Angyal, “Complexes of metal cations with carbohydrates in solution,” Adv. Carbohydr. Chem. Biochem., 47, 1-43 (1989).
[36] The Merck Index, 14^{th} ed., Merck & Co., Whitehouse Station, N.J. (2006).
[37] N. Pannetier, A. Khoukh, J. François, “Physico-chemical study of sucrose and calcium ions interactions in alkaline aqueous solutions,” Macromol. Symp., 166, 203-208 (2001).
[38] Portland Cement Association, Design and Control of Concrete Mixtures (2009).
[39] Manz, O. E., “Coal fly ash: A retrospective and future look”, Fuel, 78, 133-136 (1999).
[40] Provis, J. L., van Deventer, J. S. J. (eds.) Geopolymers. Structure, processing, properties and industrial applications. Woodhead Publishing Ltd., Cambridge (2009).

1. A composition including:
a substantially potash-free hydraulic cementitious material; and
at least one polyol compound having an acyclic polyhydroxy backbone chain comprising four or five adjacent carbon atoms, wherein a hydroxyl group is attached to each carbon of the backbone chain;
wherein the hydraulic cementitious material includes at least one calcium silicate material in a crystalline phase or at least one calcium aluminate material in a crystalline phase, or a combination thereof.

2. The composition of claim 1, wherein the one or more polyol compound is described by the chemical formula
C(OH)(R₁,R₁′)C(OH)(R₂)C(OH)(R₃)C(OH)(R₄,R₄′) (1)
or
C(OH)(R₁,R₁′)C(OH)(R₂)C(OH)(R₃)C(OH)(R₄)C(OH)(R₅,R₅′) (2)
where Rₓ and Rₓ′ represent moieties that do not contain an alcohol group in the α-position.

3. The composition of claim 1, wherein the calcium silicate material comprises one or more of tricalcium silicate and dicalcium silicate, and the calcium aluminate material comprises one or more of tricalcium aluminate and tetracalcium aluminoferrite.

4. The composition of claim 1, wherein the hydraulic cementitious material comprises portland cement.

5. The composition of claim 1, wherein the hydraulic cementitious material comprises an alkali-activated binder.

6. The composition of claim 5, wherein the alkali-activated binder is selected from slag, natural pozzolan, silica fume, fly ash, cullet, kaolinite, metakaolinite, and a combination thereof.

7. The composition of claim 1, wherein the at least one polyol compound is selected from erythritol, threitol, adonitol, xylitol, and arabitol.

8. The composition of claim 1, wherein the polyol compound is threitol.

9. The composition of claim 1, wherein the polyol compound is adonitol.

11. The composition of claim 1, wherein the polyol compound is xylitol.

12. The composition of claim 1, wherein the polyol compound is arabitol.

13. The composition of claim 1, wherein at least one polyol compound is substantially pure.

14. A method of increasing strength of a substantially potash-free hydraulic cementitious material, comprising:
adding to the hydraulic cementitious material at least one polyol compound having an acyclic polyhydroxy backbone chain comprising four or five adjacent carbon atoms, wherein a hydroxyl group is attached to each carbon of the backbone chain;
wherein the hydraulic cementitious material includes at least one calcium silicate material in a crystalline phase or at least one calcium aluminate material in a crystalline phase, or a combination thereof.

15. The method of claim 14, wherein the at least one polyol compound is described by the chemical formula
C(OH)(R₁,R₁′)C(OH)(R₂)C(OH)(R₃)C(OH)(R₄,R₄′) (1)
or
C(OH)(R₁,R₁′)C(OH)(R₂)C(OH)(R₃)C(OH)(R₄)C(OH)(R₅,R₅′) (2)
where Rₓ and Rₓ′ represent moieties that do not contain an alcohol group in the α-position.

16. The method of claim 14, comprising mixing the at least one polyol compound with water to obtain a solution, and mixing the solution with the hydraulic cementitious material.

17. The method of claim 14, wherein the calcium silicate material comprises one or more of tricalcium silicate and dicalcium silicate, and the calcium aluminate material comprises one or more of tricalcium aluminate and tetracalcium aluminoferrite.

18. The method of claim 14, wherein the hydraulic cementitious material comprises portland cement.

19. The method of claim 14, wherein the hydraulic cementitious material comprises an alkali-activated binder.

20. The method of claim 14, wherein the alkali-activated binder is selected from slag, natural pozzolan, silica fume, fly ash, cullet, kaolinite, metakaolinite, and a combination thereof.

21. The method of claim 14, wherein the at least one polyol compound is selected from erythritol, threitol, adonitol, xylitol, and arabitol.

22. The method of claim 14, wherein the polyol compound is threitol.

23. The method of claim 14, wherein the polyol compound is adonitol.

24. The method of claim 14, wherein the polyol compound is xylitol.

25. The method of claim 14, wherein the polyol compound is arabitol.

26. The method of claim 14, wherein at least one polyol compound is substantially pure.

27. An admixture for a substantially potash-free hydraulic cementitious material, comprising:
at least one polyol compound having an acyclic polyhydroxy backbone chain comprising four or five adjacent carbon atoms, wherein a hydroxyl group is attached to each carbon of the backbone chain;
wherein the hydraulic cementitious material includes at least one calcium silicate material in a crystalline phase or at least one calcium aluminate material in a crystalline phase, or a combination thereof.

28. The admixture of claim 27, wherein the polyol compound is described by the chemical formula
C(OH)(R₁,R₁′)C(OH)(R₂)C(OH)(R₃)C(OH)(R₄,R₄′) (1)
or
C(OH)(R₁,R₁′)C(OH)(R₂)C(OH)(R₃)C(OH)(R₄)C(OH)(R₅,R₅′) (2)
where Rₓ and Rₓ′ represent moieties that do not contain an alcohol group in the α-position.

29. The admixture of claim 27, wherein the calcium silicate material comprises one or more of tricalcium silicate and dicalcium silicate, and the calcium aluminate material comprises one or more of tricalcium aluminate and tetracalcium aluminoferrite.

30. The admixture of claim 27, wherein the hydraulic cementitious material comprises portland cement.

31. The admixture of claim 27, wherein the hydraulic cementitious material comprises an alkali-activated binder.

32. The admixture of claim 27, wherein the alkali-activated binder is selected from slag, natural pozzolan, silica fume, fly ash, cullet, kaolinite, metakaolinite, and a combination thereof.

33. The admixture of claim 27, wherein the at least one polyol compound is selected from erythritol, threitol, adonitol, xylitol, and arabitol.

34. The admixture of claim 27, wherein the polyol compound is threitol.

35. The admixture of claim 27, wherein the polyol compound is adonitol.

36. The admixture of claim 27, wherein the polyol compound is xylitol.

37. The admixture of claim 27, wherein the polyol compound is arabitol.

38. The admixture of claim 27, wherein the at least one polyol compound is substantially pure.

39. The admixture of claim 27, comprising an aqueous solution including the at least one polyol compound.
